(19) United States
(12) Patent Application Publication
(10) Pub. No.: US 2024/0144087 A1
(43) Pub. Date: May 2, 2024

(54) FUSION MODELS FOR BEAM PREDICTION

(71) Applicant: QUALCOMM Incorporated, San Diego, CA (US)

(72) Inventors: Fabio Valerio MASSOLI, Amsterdam (NL); Ang LI, San Diego, CA (US); Shreya KADAMBI, San Diego, CA (US); Hao YE, San Diego, CA (US); Arash BEHBOODI, Amsterdam (NL); Joseph Binamira SORIAGA, San Diego, CA (US); Bence MAJOR, Amsterdam (NL); Maximilian Wolfgang Martin ARNOLD, Amsterdam (NL)

(21) Appl. No.: 18/340,671

(22) Filed: Jun. 23, 2023

Related U.S. Application Data
(60) Provisional application No. 63/381,408, filed on Oct. 28, 2022.
(60) Provisional application No. 63/500,496, filed on May 5, 2023.

(51) Int. Cl. G06N 20/00; H04B 7/06

(52) U.S. Cl. CPC G06N 20/00; H04B 7/0695

(57) ABSTRACT

Certain aspects of the present disclosure provide techniques and apparatus for beam selection using machine learning. A plurality of data samples corresponding to a plurality of data modalities is accessed. A plurality of features is generated by, for each respective data sample of the plurality of data samples, performing feature extraction based at least in part on a respective modality of the respective data sample. The plurality of features is fused using one or more attention-based models, and a wireless communication configuration is generated based on processing the fused plurality of features using a machine learning model.

### CROSS-REFERENCE TO RELATED APPLICATIONS

This application claims priority to U.S. Provisional Patent Application No. 63/381,408, filed Oct. 28, 2022, and to U.S. Provisional Patent Application No. 63/500,496, filed May 5, 2023, the entire contents of each of which are incorporated herein by reference.

### INTRODUCTION

Aspects of the present disclosure relate to machine learning, and more particularly, to using machine learning to provide improved beam selection (e.g., in wireless communications).

Wireless communication systems are widely deployed to provide various telecommunication services such as telephony, video, data, messaging, broadcasts, etc. The current and future demands on wireless communication networks continue to grow. For example, Sixth Generation (6G) systems are expected to support applications such as augmented reality, multisensory communications, and high-fidelity holograms. These systems are further expected to serve a continuously growing number of devices while also accomplishing high standards regarding performance.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Some aspects of the present disclosure provide a method (e.g., a processor-implemented method). The method generally includes accessing a plurality of data samples corresponding to a plurality of data modalities; generating a plurality of features by, for each respective data sample of the plurality of data samples, performing feature extraction based at least in part on a respective modality of the respective data sample; fusing the plurality of features using one or more attention-based models; and generating a wireless communication configuration based on processing the fused plurality of features using a machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 depicts an example environment for using fusion-based machine learning to provide improved beam selection.

FIG. 2 depicts an example architecture for fusing and evaluating image data and location data to provide improved beam selection.

FIG. 3 depicts an example architecture for providing improved beam selection using light detection and ranging (LIDAR) data.

FIG. 4 depicts an example architecture for providing improved beam selection using radar data.

FIG. 5 depicts an example architecture for providing improved beam selection using fusion.

FIG. 6 depicts an example architecture for providing improved beam selection using sequential fusion.

FIG. 7 depicts an example workflow for pre-training and scene adaptation using simulated data.

FIG. 8 is a flow diagram depicting an example method for improved beam selection by fusing data modalities.

FIG. 9 is a flow diagram depicting an example method for pre-training and scene adaptation.

FIG. 10 is a flow diagram depicting an example method for improved wireless communication configuration using machine learning.

FIG. 11 depicts an example processing system configured to perform various aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for using machine learning to drive improved wireless communications, for example, and other applications using beams.

In some aspects, techniques are disclosed to improve wireless systems (e.g., 6G systems) use machine learning (ML) and/or artificial intelligence (AI) to leverage multimodal data and context awareness in order to provide improved communications (such as through more optimal beam selection). In some aspects, as different data modalities generally have significantly different characteristics, fusion of these different data modalities involves targeted feature extraction and fusion operations using machine learning.

In some aspects, a best or otherwise desirable wireless beam to use (e.g., by a 6G base station) to communicate with a given wireless equipment or device (e.g., user equipment (UE)) depends at least in part on the relative positioning between the transmitter and receiver, as well as the geometry of the environment. Further, beam selection may benefit from awareness about the surrounding environment(s), and other context(s). In some aspects, beam selection may be performed based on a codebook, where each entry or code in the codebook corresponds to a beam covering a specific portion or area in physical space (e.g., a direction from the transmitter). In some aspects, the codebook may generally include a set of such beams covering the whole angular space, and beams can be selected to target various regions in the physical space.

In some aspects of the present disclosure, machine learning model(s) are trained and used to predict or select, based on input data (such as images, radar data LIDAR data, global navigation satellite system (GNSS) data, and the like), a wireless radio frequency (RF) beam which is predicted to be most suitable (or among the most suitable) for a given communication. In some aspects, machine learning model performance is enhanced by exploiting different data modalities, and a fusion module capable of using the available data modalities may be provided to reach the improved prediction performance. In some aspects, as each data modality has different characteristics, specialized sub-modules (branches) are used to extract information from each of them. Further, in some aspects, the beam predictions are consistent in time for a moving UE which may be especially important when the UE moves at high speed.

In some aspects, a fusion model for beam prediction in a multimodal scenario is provided. In some aspects, the model is able to fuse different data modalities to reach improved performance for the beam prediction task. In some aspects, the fusion model includes one or more attention modules, which may allow the model itself to decide how to fuse the modalities and exploit the different modalities for each data point. In some aspects, each branch of the model is designed and specialized on a single modality, ensuring the branches can extract meaningful information from each modality. Further, in some aspects, the fusion model includes one or more recurrent modules, which allow analysis of the time evolution of the UE/environment, thus allowing for robust predictions over time.

### Example Environment for Fusion-Based Beam Selection

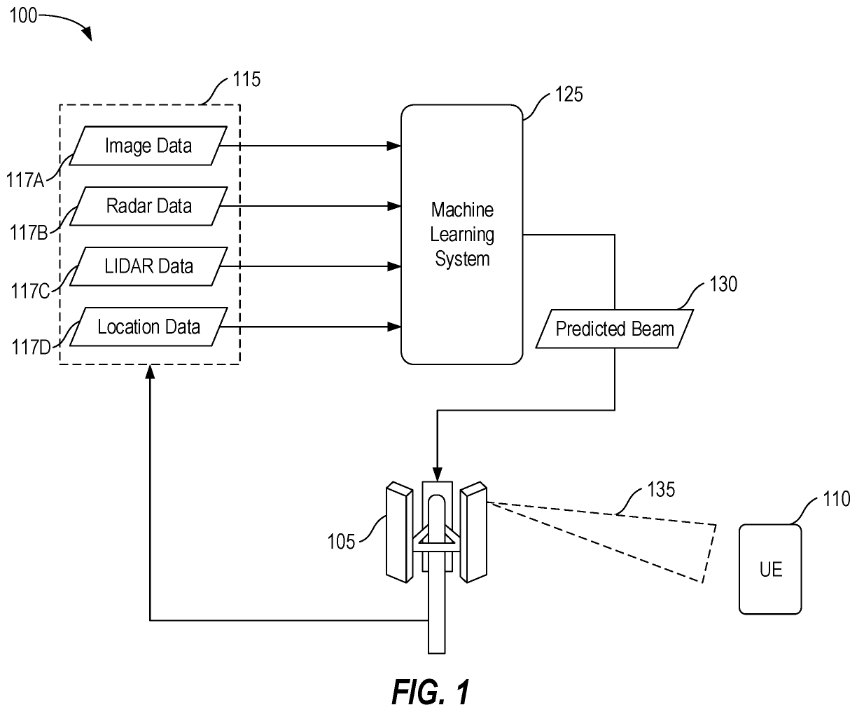

FIG. 1 depicts an example environment 100 for using fusion-based machine learning to provide improved beam selection.

In the illustrated example, a base station 105 (e.g., a next generation node B (gNB)) is configured to collect, generate, and/or receive data 115 providing environmental context for a communication. Generally, the data 115 may include data belonging to or associated with a variety of types or modalities. For example, the data 115 may include one or more modalities such as (but not limited to) image data 117A (e.g., captured by one or more cameras on or in the vicinity of the base station 105), radio detection and ranging (radar) data 117B (e.g., captured by one or more radar sensors on or in the vicinity of the base station 105), LIDAR data 117C (e.g., captured by one or more LIDAR sensors on or in the vicinity of the base station 105), location data 117D (e.g., GNSS positioning coordinates for the base station 105 and/or for one or more other objects in the vicinity, such as UE 110), and the like. As used herein, “UE” may generally refer to any wireless device or system capable of performing wireless communications (e.g., via the base station 105), such as a cellular telephone, smartphone, smart vehicle, laptop, and the like.

Although four specific modalities are depicted for conceptual clarity, in some aspects, a machine learning system 125 may use any number and variety of modalities to generate a predicted beam 130. In some aspects, the machine learning system 125 may selectively use or refrain from using one or more of the modalities depending on the particular configuration. That is, in some aspects, the machine learning system 125 may determine which modalities to use when generating the predicted beam 130, potentially refraining from using one or more modalities (e.g., refraining from using LIDAR data 117C) even if these modalities are present. In some aspects, the machine learning system 125 may assign or give higher weight to one or more modalities over the remaining modalities. For example, the machine learning system 125 may use four modalities, giving higher weight (e.g., twice the weight, or some other factor, of the other modalities) to one modality (e.g., image data) over the other modalities.

Although the illustrated example depicts the base station 105 providing the data 115 (e.g., after obtaining from another source, such as a nearby camera, vehicle, etc.), in some aspects, some or all of the data 115 may come directly from other sources (such as the UE 110) (i.e., without going through the base station 105). For example, the image data 117A may be generated using one or more cameras on or near the base station 105 (e.g., to visually identify UEs 110), while the location data 117D may be generated at least partially based on GNSS location of the UE 110. For example, the location data 117D may indicate the relative positions and/or direction of the UE 110, relative to the base station 105, as determined by GNSS coordinates of the UE 110 and a known or determined position of the base station 105. One or more of these data 117A-117D may be sent directly to the machine learning system 125.

In the illustrated example, the base station 105 can use a variety of configurations or parameters to control a beam 135 used to communicate with the UE(s) 110. For example, in multiple-input, multiple-output (MIMO) aspects, the base station 105 may use or control various beamforming codebooks, dictionaries, phase shifters, and the like in order to change the focus of the beam 135 (e.g., to change where the center or focus of the beam 135 is located). By steering or adjusting the beam 135 appropriately (e.g., selecting a specific beam), the base station 105 may be able to provide or improve the communications with the UE 110. In the illustrated example, the UE 110 may be moving. In such moving aspects (and particularly when the UE 110 moves rapidly), appropriate beam selection can enable significantly improved results.

Though a single base station 105 and a single UE 110 are depicted for conceptual clarity, in aspects, there may be any number of base stations and UEs. Further, though a 6G base station 105 is depicted for conceptual clarity, in aspects, the base station 105 may include or be configured to provide wireless communications using any standards or techniques, such as 5G, 4G, WiFi, and the like.

In some aspects, the collected data 115 includes a time sequence or series. That is, within at least one of the modalities, a set or sequence of data points may be present. For example, the data 115 may include a series of images or frames from a video, a series of radar measurements, and the like. In some aspects the machine learning system 125 may process the data 115 as a sequence (e.g., generating the predicted beam 130 based on a sequence of timestamps or data points, where each timestamp or data point may include data from multiple modalities) and/or as discrete data points (e.g., generating the predicted beam 130 for each timestamp or data point, where each timestamp or data point may include data from multiple modalities).

In some aspects, prior to processing the data 115 with one or more machine learning models, the machine learning system 125 may first perform various preprocessing operations. In some aspects, the machine learning system 125 may synchronize the data 115 for each modality. For example, for a given data point in a given modality (e.g., a given frame of the image data 117A), the machine learning system 125 may identify the corresponding data point(s) in each other modality (e.g., the radar captured at the same timestamp, the LIDAR captured at the same timestamp, the location data captured at the same timestamp, and the like).

In some aspects, the machine learning system 125 may perform extrapolation on the data 115 if appropriate. For example, if the location data 117D is only available for a subset of the timestamps, then the machine learning system 125 may use the available location data to determine or infer the relative movement (e.g., speed and/or direction) of the UE, and use this movement to extrapolate and generate data points at the corresponding timestamps to match the other modalities in the data 115.

In some aspects, the machine learning system 125 processes the data 115 independently for each timestamp (e.g., generating the predicted beam 130 for each timestamp). In some aspects, the machine learning system 125 processes the data 115 from windows of time. That is, rather than evaluate the data 115 corresponding to a single time, the machine learning system 125 may evaluate N data points or timestamps jointly to generate the predicted beam 130, where N may be a hyperparameter configured by a user or administrator, or may be a learned value. For example, the machine learning system may use five data points from each modality (e.g., five images, five radar signatures, and the like). In some aspects, the time spacing between data points (e.g., whether the data points are one second apart, five seconds apart, etc.) may similarly be a hyperparameter configured by a user or administrator, or may be a learned value.

In some aspects, the machine learning system 125 may calibrate or convert one or more of the modalities, such as the location data 117D, to a local reference frame to improve generalization of the models. For example, the machine learning system 125 may convert the position information (e.g., GNSS coordinates of the base station 105 and/or UE 110) to a Cartesian coordinate system (e.g., (x, y) coordinates). The machine learning system 125 can then convert the position of the UE 110 from a global reference frame to a local reference frame, such as by subtracting the coordinates of the base station 105 from the coordinates of the UE 110. In some aspects, the machine learning system 125 can then convert this local position of the UE 110 (relative to the base station 105) to a radius r and angle α, relative to the base station 105 in polar coordinates.

In the illustrated example, the machine learning system 125 evaluates the data 115 (e.g., independently or as a sequence of points) to generate the predicted beam 130. As discussed above, the predicted beam 130 corresponds to the beam that is predicted to have the best or most optimal characteristics for communication with the UE 110. As illustrated, this predicted beam 130 is provided to the base station 105, which uses the predicted beam to select the beam 135 for the communications.

In some aspects, this process may be repeated (e.g., continuously, intermittently, or periodically) or until terminated. For example, the machine learning system 125 may repeatedly evaluate the data 115 continuously as the data is received and/or periodically (e.g., every five seconds) to generate a new beam prediction, allowing the base station 105 to continue to select the (optimal) beam 135 for communication with the UE 110. As discussed above, though a single UE 110 is depicted for conceptual clarity, in some aspects, the machine learning system 125 may similarly evaluate corresponding data 115 for each UE 110 and generate a corresponding predicted beam 130 for each.

Generally, the machine learning model(s) used by the machine learning system 125 may be trained and/or used by any suitable computing system, and the machine learning system 125 may be implemented by any suitable system. For example, the base station 105 may itself contain or be associated with computing resources that train and/or implement the machine learning system 125. In other aspects, the data 115 may be provided to a remote system to train and/or implement the model(s). For example, a cloud system may train the models, and the trained model may be used by the cloud system or by another system (such as the base station 105 or the machine learning system 125) to generate the predicted beam 130. In other examples, some or all of the data 115 may be collected by and/or provided to the UE 110 to train the model (or a portion thereof) on the UE 110 and/or to use the trained model to generate beam predictions.

In some aspects, the machine learning system 125 uses a fusion approach to dynamically fuse the data 115 from each modality, enabling improved beam prediction that enhances the communication robustness and throughput.

### Example Architectures for Fusion-Based Beam Selection

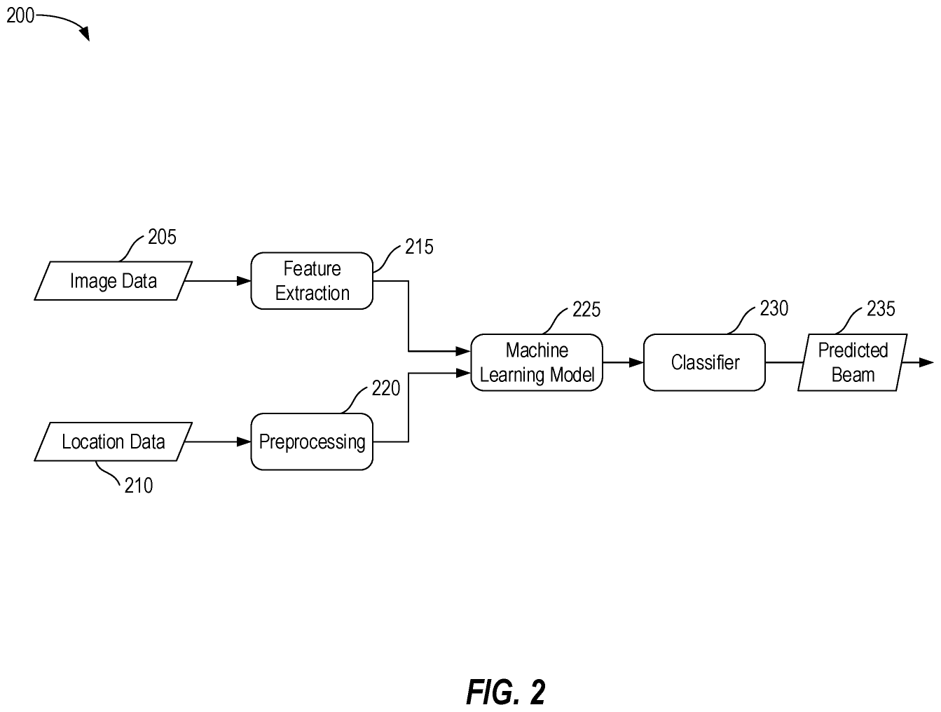

FIG. 2 depicts an example architecture 200 for fusing and evaluating image data and location data to provide improved beam selection. In some aspects, the architecture 200 is used by a machine learning system, such as the machine learning system 125 of FIG. 1.

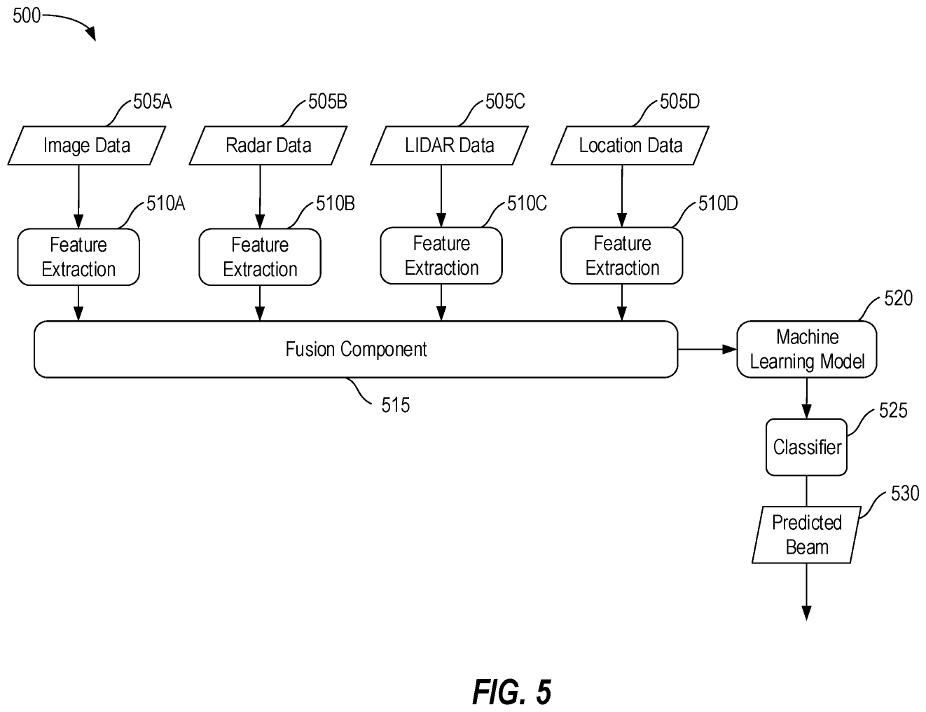

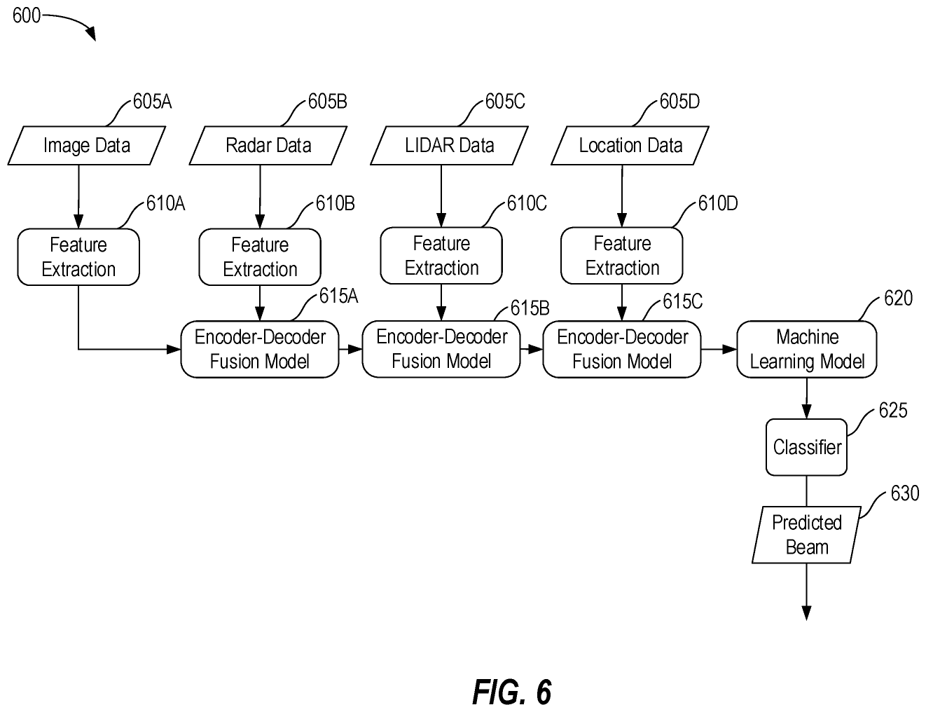

Specifically, in the illustrated example, the architecture 200 is configured to evaluate image data 205 and location data 210 to generate a predicted beam 235 (e.g., selected or predicted to be the optimal beam for a communication, such as in terms of robustness, throughput, and the like). In some aspects, some or all of the architecture 200 may be used as part of a fusion model, rather than as a standalone model. For example, as discussed in more detail below, the feature extraction and/or preprocessing performed in feature extraction 215 and/or preprocessing 220 may be used to provide feature extraction and/or preprocessing at feature extraction 510A and/or feature extraction 510D of FIG. 5, and/or feature extraction 610A and/or feature extraction 610D of FIG. 6. In some aspects, the image data 205 and the location data 210 correspond to the data 115 of FIG. 1 (e.g., corresponding to the image data 117A and the location data 117D, respectively).

In the illustrated example, the image data 205 is first processed using the feature extraction 215. Generally, the feature extraction 215 can comprise a wide variety of operations and techniques to extract or generate features based on the image data 205. For example, in some aspects, the feature extraction 215 corresponds to one or more trained models, such as feature extractor neural networks, that are trained to generate or extract output features based on the input image data 205. As an example, in some aspects, the feature extraction 215 may be performed using a pre-trained model (e.g., a ResNet50 model) with a multilayer perceptron (MLP) used as the final or output layer of the feature extraction 215 (rather than a conventional classifier layer). In some such aspects, the MLP may include a linear layer followed by a batch normalization layer followed by a second linear layer followed by a second batch normalization layer and finally followed by a third linear layer. In aspects, the specific architecture of the feature extraction 215 may vary depending on the particular implementation. Generally, any architecture that receives an input image and outputs extracted or generated features may be used.

Generally, the feature extraction 215 can be used to generate or extract features for each data point in the image data 205. That is, for each frame or image, a corresponding set of features can be generated by the feature extraction 215. These features can then be provided as input to a machine learning model 225. In some aspects, these features are provided independently for each image frame (e.g., rather than a sequence). In some aspects, these features are provided as a sequence or time series, as discussed above. For example, if a sequence of features is used, any architecture that receives a sequence of input data points may be used, such as a gated recurrent unit (GRU) network, a recurrent neural network (RNN), a long short-term memory (LSTM) architecture, and the like may be used as the machine learning model 225.

In the illustrated example, the location data 210 (e.g., coordinates and/or movement of the base station and/or UE, such as determined via global positioning satellite (GPS) or other locationing technologies) are first processed using the preprocessing 220. The preprocessing 220 may generally include any relevant operations or transformations. For example, in some aspects, the preprocessing 220 may include extrapolating any incomplete location data 210 to match the timestamps of the image data 205. For example, if there are five timestamps in the image data 205 and only a subset of these timestamps are available in the location data 210, then the preprocessing 220 may include inferring or determining the UE position based on the trajectory of the UE (relative to the base station), as indicated in the existing location data 210. That is, given the trajectory of the UE relative to the base station position, the preprocessing 220 may include inferring the UE's position at the next time step(s).

Generally, the preprocessing 220 can be used to generate or extract features for each data point or timestamp. That is, for each timestamp being used (e.g., for each data point in the image data 205), a corresponding set of features (e.g., relative positions, angles, ranges, trajectories, and the like) can be generated or determined by the preprocessing 220. This data can then be provided (individually or as a sequence) as input to the machine learning model 225.

In some aspects, rather than providing the extracted image features and location data separately, the machine learning system may first combine the image features and location features. For example, at each timestamp, the machine learning system may concatenate, sum, or otherwise aggregate or fuse the image features and location features. In this way, the system generates a combined or concatenated set of features based on the image data 205 and the location data 210. This combined data (or sequence) can then be used as input to the machine learning model 225. In some aspects, if data from one modality (e.g., image data) has no corresponding data for the same timestamp in another modality (e.g., there is no location data for the time), the image data may be discarded or otherwise weighted less, as compared to data having a corresponding counterpart in the other modality.

In some aspects, if a recurrent or time-series model is used (such as a GRU), the machine learning model 225 may include a set of nodes (e.g., one for each timestamp in the input sequence). The input to a given node may include the features at a given timestamp in the data, as well as the output of the prior node. That is, the first node may receive the features at the first timestamp to generate an output, and the second node may receive the features at the second timestamp, along with the output of the first node, to generate a second output. This process may continue until the final node, where the output of the final node may be output by the machine learning model 225 or may be processed (e.g., using a classifier) to generate an output prediction.

In the illustrated example, the machine learning model 225 outputs data or features to a classifier 230 (e.g., an MLP). Generally, any classifier architecture may be used. For example, in some aspects, the classifier 230 may be an MLP including a linear layer, a layer for dropout, a nonlinear layer (e.g., a rectified linear unit (ReLU) operation), and another linear layer.

As illustrated, the classifier 230 outputs the predicted beam 235. As discussed above, this predicted beam 235 may correspond to the beam which is predicted or expected to provide the best available communications to a UE, such as the most robustness, the highest throughput, and the like.

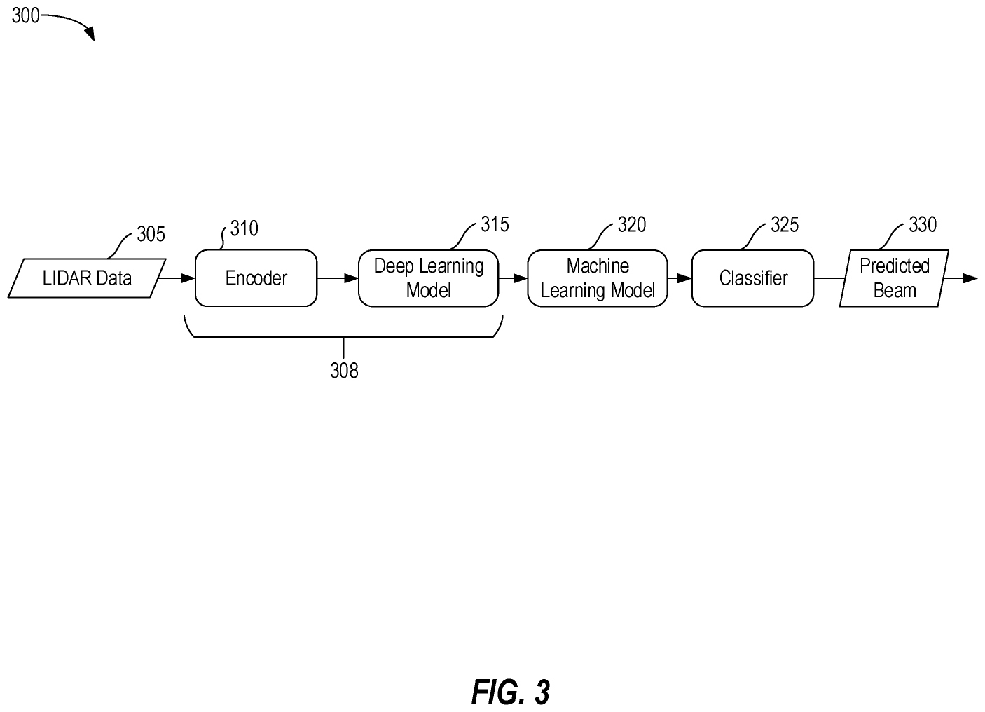

FIG. 3 depicts an example architecture 300 for providing improved beam selection using LIDAR data. In some aspects, the architecture 300 may be used by a machine learning system, such as the machine learning system 125 of FIG. 1. In some aspects, the architecture 300 may be used in addition to the architecture 200 of FIG. 2. In other aspects, the architecture 300 may be used in alternative of the architecture 200 of FIG. 2.

Specifically, in the illustrated example, the architecture 300 is configured to evaluate LIDAR data 305 (e.g., the LIDAR data 117C of FIG. 1) to generate a predicted beam 330 (e.g., selected or predicted to be the optimal beam for a communication, such as in terms of robustness, throughput, and the like). In some aspects, some or all of the architecture 300 may be used as part of a fusion model, rather than as a standalone model. For example, as discussed in more detail below, the feature extraction performed in encoder 310 and deep learning model 315 may be used to provide LIDAR feature extraction in feature extraction 510C of FIG. 5 and/or feature extraction 610C of FIG. 6.

In the illustrated example, the LIDAR data 305 is first processed using a feature extraction 308 (also referred to in some aspects as an embedding network), comprising an encoder 310 and a deep learning model 315. Generally, the feature extraction 308 can comprise a wide variety of operations and techniques to extract or generate features based on the LIDAR data 305. For example, in some aspects, the feature extraction 308 may correspond to one or more trained models that are trained to generate or extract output features or generate embeddings based on the input LIDAR data 305. In the illustrated example, the encoder 310 may be implemented as a model that operates on point clouds (e.g., LIDAR data) to perform efficient convolution. In some aspects, the encoder 310 comprises a PointPillar network.

Further, the deep learning model 315 may generally correspond to any suitable architecture, such as a neural network. In some aspects, the deep learning model 315 is used to reduce the number of dimensions of the extracted features generated by the encoder 310. In some aspects, the deep learning model 315 is a PointNet.

Generally, the feature extraction 308 can be used to generate or extract features for each data point in the LIDAR data 305. That is, for each point cloud (or other data structure used to represent the LIDAR data 305), a corresponding set of features can be generated by the feature extraction 308. These features can then be provided (independently or as a sequence) as input to a machine learning model 320. In some aspects, a GRU network or other recurrent architecture (e.g., an RNN, an LSTM, and the like) can be used if the model operates on a sequence of data.

In some aspects, as discussed above, to process sequential data, the machine learning model 320 can include a set of nodes (e.g., one for each timestamp in the input data), where the input to a given node may include the features at a given timestamp in the data, as well as the output of the prior node. In the illustrated example, the machine learning model 320 outputs data or features to a classifier 325. As discussed above, the classifier 325 may be implemented using a variety of architectures, such as an MLP. In some aspects, the classifier 325 is an MLP including a single linear layer.

As illustrated, the classifier 325 outputs the predicted beam 330. As discussed above, this predicted beam 330 may correspond to the beam which is predicted or expected to provide the best available communications to the UE, such as the most robustness, the highest throughput, and the like.

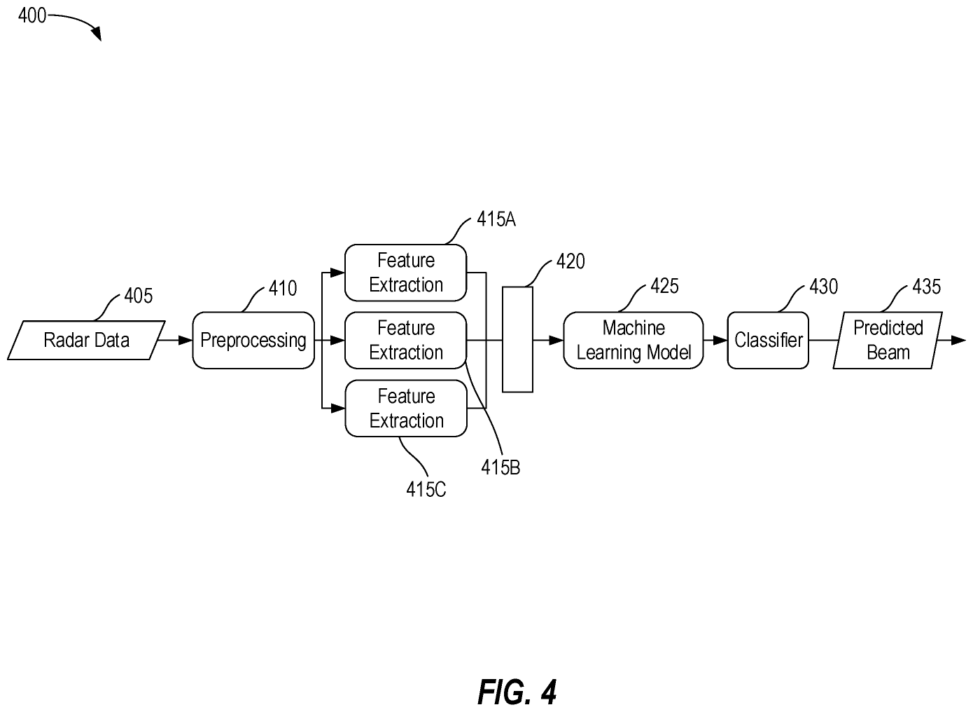

FIG. 4 depicts an example architecture 400 for providing improved beam selection using radar data. In some aspects, the architecture 400 may be used by a machine learning system, such as the machine learning system 125 of FIG. 1. In some aspects, the architecture 300 may be used in addition to the architecture 200 of FIG. 2 and/or the architecture 300 of FIG. 3. In other aspects, the architecture 300 may be used in alternative of the architecture 200 of FIG. 2 and/or the architecture 300 of FIG. 3.

Specifically, in the illustrated example, the architecture 400 is configured to evaluate radar data 405 (e.g., the radar data 117B of FIG. 1) to generate a predicted beam 435 (e.g., selected or predicted to be the optimal beam for a communication, such as in terms of robustness, throughput, and the like). In some aspects, some or all of the architecture 400 may be used as part of a fusion model, rather than as a standalone model. For example, as discussed in more detail below, the feature extraction performed in preprocessing 410 and feature extractions 415A-C may be used to provide radar feature extraction in feature extraction 510B of FIG. 5 and/or feature extraction 610B of FIG. 6.

In the illustrated example, the radar data 405 is first preprocessed at the preprocessing 410. In some aspects, at the preprocessing 410, a number of different outputs are generated or extracted for each data point/sample in the radar data 405. For example, the preprocessing 410 may generate or extract, for each timestamp or data point, a range-velocity map (which may be denoted V in some aspects), a range-angle map (which may be denoted R in some aspects), and/or a radar cube (which may be denoted X in some aspects).

Generally, the preprocessing 410 can be used to generate or extract outputs for each data point in the radar data 405. For example, for each image (or other data structure used to represent the radar data), a corresponding range-velocity map, range-angle map, and radar cube can be generated by the preprocessing 410.

In the illustrated example, each of these preprocessed data outputs is provided to a respective specific feature extraction 415A-C. Generally, each feature extraction 415A-C (collectively, feature extractions 415) can comprise a wide variety of operations and techniques to extract or generate features based on the radar data 405. For example, in some aspects, the feature extractions 415 for the radar data 405 may include use of a constant false alarm rate (CFAR) adaptive algorithm to generate feature output.

As another example, one or more of the feature extractions 415 may correspond to machine learning models, such as neural networks trained to generate or extract features from the corresponding radar output (e.g., where the feature extraction 415A extracts features from the range-velocity maps, the feature extraction 415B extracts features for the radar cube, and the feature extraction 415C extracts features for the range-angle map).

As illustrated, for each exemplar in the radar data 405 (e.g., each timestamp or data point), a corresponding set of learned features 420 can therefore be compiled (e.g., by combining, concatenating, or reshaping the output of each feature extraction 415 for the input radar data 405). By doing so for each of the pieces of radar data 405, a set or sequence of learned features 420 is generated.

The learned features 420 can then be provided (as a sequence and/or independently) as input to a machine learning model 425. In some aspects, if a sequence of features is used, any architecture that receives a sequence of input data points—such as a GRU network, an RNN, an LSTM architecture, and the like—may be used as the machine learning model 425.

In some aspects, as discussed above, to process sequential data, the machine learning model 425 can include a set of nodes (e.g., one for each timestamp in the input data), where the input to a given node may include the features at a given timestamp in the data, as well as the output of the prior node. In the illustrated example, the machine learning model 425 outputs data or features to a classifier 430. In some aspects, the classifier 430 comprises an MLP including a linear layer, followed by a dropout layer, followed by a nonlinear layer (e.g., ReLU), and followed by a final linear layer.

As illustrated, the classifier 430 outputs the predicted beam 435. As discussed above, this predicted beam 435 may correspond to the beam which is predicted or expected to provide the best available communications to the UE, such as the most robustness, the highest throughput, and the like.

In some aspects, some or all of the architectures 200, 300, and/or 400 may be combined using fusion techniques to generate improved beam predictions. FIG. 5 depicts an example architecture 500 for providing improved beam selection using fusion. In some aspects, the architecture 500 may be used by a machine learning system, such as the machine learning system 125 of FIG. 1.

As discussed above, in some architectures, data from different modalities may be fused to provide improved beam selection. Although FIGS. 3 and 4 depict single-modality feature extraction and beam selection for conceptual clarity, in some aspects, some or all of the modalities may be fused in a single architecture. For example, the architecture 500 is configured to fuse an image modality (represented by image data 505A, which may correspond to the image data 117A of FIG. 1), a radar modality (represented by radar data 505B, which may correspond to the radar data 117B of FIG. 1), a LIDAR modality (represented by LIDAR data 505C, which may correspond to the LIDAR data 117C of FIG. 1), and a location modality (represented by location data 505D, which may correspond to the location data 117D of FIG. 1).

Although the illustrated example depicts using four different modalities, in aspects, the architecture may use fewer modalities or may use additional modalities not pictured (e.g., by adding more feature extraction components for new modalities). Additionally, in some aspects, the machine learning system may selectively enable or disable various modalities. That is, in some aspects the machine learning system may dynamically determine whether to use data from each modality to generate predicted beams (e.g., whether to use a subset of the modalities at one or more times).

In the illustrated example, each modality of the input data 505 undergoes modality-specific feature extraction 510. For example, the image data 505A undergoes image feature extraction 510A (which may correspond to the feature extraction 215 of FIG. 2), the radar data 505B undergoes radar feature extraction 510B (which may correspond to the preprocessing 410 and/or the feature extractions 415A-C of FIG. 4), the LIDAR data 505C undergoes LIDAR feature extraction 510C (which may correspond to the feature extraction 308 of FIG. 3), and the location data 505D undergoes feature extraction 510D (which may correspond to the preprocessing 220 of FIG. 2).

In the illustrated architecture 500, the image features (output by the image feature extraction 510A), the radar features (output by the radar feature extraction 510B), the LIDAR features (output by the LIDAR feature extraction 510C), and the location features (output by the location feature extraction 510D) are provided to a fusion component 515. In some aspects, the fusion component 515 is a machine learning model trained to fuse the features from each modality to generate a unified or aggregated set of features. In some aspects, the fusion component 515 uses one or more attention-based mechanisms to fuse the features. In some aspects the fusion component 515 uses operations such as concatenation, summing, stacking, averaging, and the like to aggregate and fuse the features.

Advantageously, if the fusion component 515 is a trained model, the machine learning system can thereby learn (during training) an optimal, or at least an improved, way to fuse the extracted features, such as using an attention-based mechanism. In some aspects, as discussed above, the fusion component 515 may selectively or dynamically select which features or modalities to fuse, depending on a variety of criteria or implementation details. For example, the fusion component 515 may determine which features are available (e.g., to fuse the features from any modalities with available data), and/or may evaluate the features themselves to determine whether to fuse them (e.g., determining whether to include features from a given modality based on whether the features satisfy some defined criteria, such as a maximum sparsity).

In the illustrated example, therefore, the fusion component 515 can thereby be used to fuse features from any number of modalities. In some aspects, during or prior to training, the architecture 500 may be modified (e.g., adding or removing feature extractions 510 to add or remove modalities), allowing the fusion model to be trained for any specific combination of modalities. In some aspects, unused modalities may be left in the architecture. For example, during training, the machine learning system may refrain from providing input data for any unused or undesired modalities, and the system may learn to effectively bypass these features when fusing the modalities.

In some aspects, as discussed above, the fusion component 515 can fuse features with respect to each timestamp or data point. That is, the machine learning system may, for each given timestamp, fuse the corresponding features from each modality to generate a set of fused features for the given timestamp. In some aspects, these fused features can be evaluated independently for each timestamp (generating a corresponding predicted beam for each timestamp), as discussed above. In other aspects, the fused features may be evaluated as a series or sequence (e.g., evaluating a window of five sets of fused features) to generate the predicted beams.

As illustrated, once fused features have been generated, the fused features are provided as input to a machine learning model 520. For example, the machine learning model 520 may correspond to or comprise the machine learning model 225 of FIG. 2, the machine learning model 320 of FIG. 3, the machine learning model 425 of FIG. 4, and/or the like. In some aspects, as discussed above, the machine learning model 520 processes the fused features as a time-series. For example, the machine learning model 520 may comprise a GRU network, an RNN, an LSTM, and the like.

In the illustrated example, the machine learning model 520 outputs features or other data to a classifier 525 (e.g., an MLP). For example, in some aspects, the classifier 525 comprises an MLP that includes a linear layer, followed by a dropout layer, followed by a nonlinear layer (e.g., ReLU), and followed by a final linear layer.

As illustrated, the classifier 525 outputs the predicted beam 530. As discussed above, this predicted beam 530 may correspond to the beam which is predicted or expected to provide the best available communications to the UE, such as the most robustness, the highest throughput, and the like. Advantageously, by fusing multiple modalities, the machine learning system is generally able to generate more accurate beam predictions (e.g., more accurately selecting beam(s) that will improve or result in good quality communications with the UE).

FIG. 6 depicts an example architecture 600 for providing improved beam selection using sequential fusion. In some aspects, the architecture 600 may be used by a machine learning system, such as the machine learning system 125 of FIG. 1.

As discussed above, in some architectures, data from different modalities may be fused to provide improved beam selection. In the illustrated example, the architecture 600 is configured to fuse modalities using a sequential fusion process. Specifically, the architecture 600 includes an image modality (represented by image data 605A, which may correspond to the image data 117A of FIG. 1), a radar modality (represented by radar data 605B, which may correspond to the radar data 117B of FIG. 1), a LIDAR modality (represented by LIDAR data 605C, which may correspond to the LIDAR data 117C of FIG. 1), and a location modality (represented by location data 605D, which may correspond to the location data 117D of FIG. 1).

Although the illustrated example depicts using four different modalities, in aspects, the architecture may use fewer modalities or may use additional modalities not pictured (e.g., by adding more encoder-decoder fusion models 615, as discussed below in more detail). Additionally, though the illustrated example depicts a particular sequence of modalities (e.g., where image data and radar data are first processed, followed by LIDAR data, and finally followed by location data), the particular ordering used may vary depending on the particular implementation.

In the illustrated example, each modality of input data undergoes modality-specific feature extraction. For example, the image data 605A undergoes image feature extraction 610A (which may correspond to the feature extraction 215 of FIG. 2), the radar data 605B undergoes radar feature extraction 610B (which may correspond to the preprocessing 410 and/or the feature extractions 415A-C of FIG. 4), the LIDAR data 605C undergoes LIDAR feature extraction 610C (which may correspond to the feature extraction 308 of FIG. 3), and the location data 605D undergoes feature extraction 610D (which may correspond to the preprocessing 220 of FIG. 2).

In the illustrated architecture 600, the image features (output by the image feature extraction 610A) and the radar features (output by the radar feature extraction 610B) are provided to a first encoder-decoder fusion model 615A. Generally, the encoder-decoder fusion model 615A is an attention-based machine learning model. For example, the encoder-decoder fusion model 615A may be implemented using one or more transformer blocks (e.g., vision transformers). In some aspects, to provide the features, the system can reshape the image features and radar features from a single timestamp such that these features are in the proper format for the encoder-decoder fusion model 615A. The encoder-decoder fusion model 615A can then process these features to generate fused features for the image data 605A and the radar data 605B.

Advantageously, the encoder-decoder fusion model 615A can thereby learn (during training) how to fuse the extracted features, using an attention-based mechanism. As illustrated, the fused features are then output to a second encoder-decoder fusion model 615B, which also receives the LIDAR features (generated by the feature extraction 610C).

Generally, as discussed above, the encoder-decoder fusion model 615B is also an attention-based machine learning model. For example, the encoder-decoder fusion model 615B may be implemented using one or more transformer blocks (e.g., vision transformers). In some aspects, as discussed above, the system can reshape the fused image features and radar features along with the LIDAR features from a corresponding timestamp such that these features are in the proper format for the encoder-decoder fusion model 615B. The encoder-decoder fusion model 615B can then generate a new set of fused features based on a first set of intermediate fused features (generated by the encoder-decoder fusion model 615A, based on the image data 605A and the radar data 605B) and the LIDAR data 605C.

As illustrated, the fused features are then output to a third encoder-decoder fusion model 615C, which also receives the location features (generated by the feature extraction 610D).

Generally, as discussed above, the encoder-decoder fusion model 615C can also include an attention-based machine learning model, which may be implemented using one or more transformer blocks (e.g., vision transformers). In some aspects, the system can similarly reshape the fused image features, radar features, and LIDAR features along with the location features from a corresponding timestamp such that these features are in the proper format for the encoder-decoder fusion model 615C. The encoder-decoder fusion model 615C can then generate fused features for all of the input data modalities at a given timestamp.

In some aspects, the encoder-decoder fusion models 615 can thereby be used to fuse features from any number of modalities (e.g., where encoder-decoder fusion models may be added or removed depending on the modalities used). That is, during or prior to training, the architecture 600 may be modified (e.g., adding or removing encoder-decoder fusion models to add or remove modalities), allowing the fusion model to be trained for any specific combination of modalities. Alternatively, in some aspects, unused encoder-decoder fusion models and/or modalities may be left in the architecture. During training, as no input data is provided for the missing modality (or modalities), the model may learn to effectively bypass the corresponding encoder-decoder fusion models (e.g., where data passes through these models unchanged).

As illustrated, once fused features have been generated, the fused features are provided as input to a machine learning model 620. For example, the machine learning model 620 may correspond to or comprise the machine learning model 225 of FIG. 2, the machine learning model 320 of FIG. 3, the machine learning model 425 of FIG. 4, and the like. In some aspects, as discussed above, the machine learning model 620 processes the fused features as a time-series. For example, the machine learning model 620 may comprise a GRU network, an RNN, an LSTM, and the like.

In the illustrated example, the machine learning model 620 outputs features or other data to a classifier 625 (e.g., an MLP). For example, in some aspects, the classifier 625 comprises an MLP that includes a linear layer, followed by a dropout layer, followed by a nonlinear layer (e.g., ReLU), and followed by a final linear layer.

As illustrated, the classifier 625 outputs the predicted beam 630. As discussed above, this predicted beam 630 may correspond to the beam which is predicted or expected to provide the best available communications to the UE, such as the most robustness, the highest throughput, and the like. Advantageously, by fusing multiple modalities, the machine learning system is generally able to generate more accurate beam predictions (e.g., more accurately selecting beam(s) that will improve or result in good quality communications with the UE).

Additionally, by using attention-based models to fuse the features from each modality, the architecture 600 is able to achieve high robustness and accuracy (e.g., reliably selecting or suggesting the most-optimal beam for the communications).

### Example Workflow for Pre-Training and Scene Adaptation Using Simulated Data

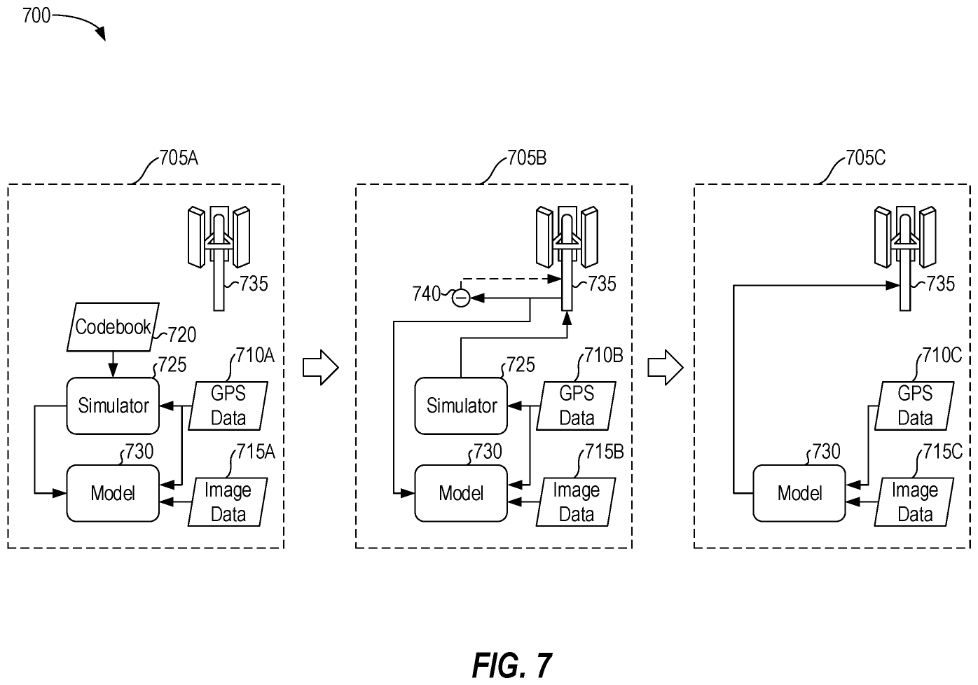

FIG. 7 depicts an example workflow 700 for pre-training and scene adaptation using simulated data. In some aspects, the workflow 700 is performed by a machine learning system, such as the machine learning system 125 of FIG. 1. In some aspects, the workflow 700 is performed entirely or partially by a dedicated training system. For example, one part of the workflow 700 (e.g., pre-training using synthetic data in block 705A) may be performed by a dedicated training system, and scene or environment adaptation (in block 705B) may be performed by a machine learning system that uses trained models to generate predicted beams during runtime. As discussed above, this predicted beam may correspond to the beam which is predicted or expected to provide the best available communications to the UE, such as the most robust, the highest throughput, and the like. In some aspects, by leveraging synthetic data to pre-train and adapt the machine learning model(s), the workflow 700 enables significantly improved prediction accuracy with reduced training data.

In some aspects, to perform pre-training (in block 705A), synthetic data can be created based on a codebook 720 (referred to as “CB” in some aspects) and a simulator 725. As discussed above, the codebook 720 generally comprises or indicates a set of beams, each targeting a specific angular direction relative to a base station 735. Generally, the simulator 725 may correspond to a model or representation of received power over various angles of arrival based on the specific codebook entry used (e.g., the beam selected) for a transmission. That is, the simulator 725 may be a received power simulator that can be used to determine, predict, or indicate, for a specific angle of arrival and/or angle of departure (e.g., based on relative angle information such as the angle of the receiving UE relative to the transmitting base station 735), the predicted received power (at the UE) of a signal transmitted by the base station 735 and/or the predicted received power (at the base station 735) of a signal transmitted by the UE as a function of the codebook entry used for the transmission.

For example, the transmission properties of the antenna(s) of the base station 735 may be measured in an anechoic chamber, and the profile of the codebook 720 may be captured or determined (indicating power profiles of each codebook element over various angles of arrival/departure). These profiles can then be applied to predict the best beams based on angle of arrival (e.g., by the simulator 725). In some aspects, as direct generalization through a large amount of training data and measurement is not feasible (e.g., it is not practical, or in some cases even possible, to gather true label data for real environments), model generalization can be promoted or improved by deploying the depicted synthetic augmentation pre-training step at block 705A.

Specifically, as illustrated in block 705A, the physical positions of the transmitting base station 735 and/or the UE can be determined (or simulated), as illustrated by GPS data 710A in the depicted figure. This (real or simulated) GPS data 710A can be used to determine or estimate the angle of arrival and/or angle of departure of a line-of-sight (LOS) signal between the base station 735 and UE, as discussed above. In some aspects, the GPS data 710A is also used to determine or estimate the range or distance to the UE. The simulator 725 can then be used to predict the best beam(s) based on that angle of arrival or departure and/or based on the range. As illustrated, this output prediction (from the simulator) can be used as the target or label for training a machine learning model 730.

Generally, the machine learning model 730 may include a variety of components and architectures, including various feature extraction or preprocessing operations, fusion of multiple modalities (using a learned fusion model and/or static fusion techniques), deep learning models, beam prediction or classification components (e.g., MLPs), and the like. For example, depending on the particular modalities supported, the machine learning model 730 comprises one or more of the feature extraction 215, preprocessing 220, machine learning model 225, and/or classifier 230 of FIG. 2, the feature extraction 308, machine learning model 320, and/or classifier 325 of FIG. 3, the preprocessing 410, feature extraction 415, machine learning model 425, and/or classifier 430 of FIG. 4, the feature extraction 510, fusion component 515, machine learning model 520, and/or classifier 525 of FIG. 5, and/or the feature extraction 610, encoder-decoder fusion models 615, machine learning model 620, and/or classifier 625 of FIG. 6.

In the illustrated example, during this pre-training block 705A, the machine learning model 730 receives (as input) data from one or more available modalities (e.g., GPS data 710A and image data 715A in the illustrated example). In some aspects, these modalities may undergo various feature extraction and/or fusing operations, as discussed above. Using these inputs, the machine learning model 730 predicts or selects one or more best beams. That is, based on the relative positions and/or captured image(s), the machine learning model 730 predicts which beam(s) will result in the most optimal communication with the UE. During pre-training block 705A, the predicted beam(s) can be compared against the beam(s) selected or predicted by the simulator 725 (used as a label, as discussed above), and the difference(s) can be used to generate a loss. The machine learning system may then use this loss to refine the machine learning model 730.

In aspects, this pre-training step (at block 705A) may be performed using any number of exemplars (e.g., any number of input samples, each including positional information (e.g., GPS data 710A) and/or one or more other modalities (e.g., image data 715A)) during block 705A.

In some aspects, because the simulator 725 predicts the best beam based on LOS (e.g., based on the GPS data 710A and/or relative positions or angles, predicting that the best beam will be the LOS beam), the machine learning model 730 may learn an alignment or mapping between angle of arrival and/or departure and codebook entries in the codebook 720 (e.g., beams). However, in some aspects, scene or environment-specific scenarios (such as terrain, objects that may block or reflect RF waves, and the like) can be accounted for during adaptation stages (e.g., at block 705B). That is, during pre-training in block 705A, the machine learning model 730 may learn to predict the LOS beam as the best beam, although in real scenarios, other beams may be better-suited (e.g., due to reflections and/or obscuring objects).

In some aspects, one or more additional modalities (e.g., image data 715A from a camera), in conjunction with the positioning data (e.g., GPS data 710A), can be leveraged during the pre-training step in block 705A to assist the machine learning model 730 to learn to become invariant to other (non-communication) changes, such as UE changes. For example, if image data 715A is used as input during training, the machine learning model 730 may learn to generalize with respect to the specific UE type or appearance (e.g., to predict the LOS beam regardless of whether the UE is a car, laptop, smartphone, or other object with a different visual appearance). Other modalities may similarly be used during pre-training to allow the machine learning model 730 to become invariant with respect to such other modalities.

As discussed above, full measurements of the beams (used by some conventional approaches to train models) create vast amounts of data and take long periods of time to collect (e.g., if one would try to sweep all beams for each possible UE position). Indeed, such data collection may often be impractical or entirely impossible for real environments. In some aspects, the machine learning system can minimize or eliminate this overhead using pre-training block 705A. Additionally, in some aspects, the machine learning system may reduce this overhead by using an adaptation stage illustrated in block 705B to select the information content of the full measurement based on only one initial beam measurement, as discussed below in more detail. In some aspects, this on-the-fly measurement selection process is referred to as scene or environment adaptation, where the machine learning system trains or updates the machine learning model 730 based on data from the specific environment where the base station 735 is deployed.

Specifically, leveraging the pre-training step in block 705A, the machine learning system can use a threshold-based metric to determine which real-world measurements should be collected for further refinement of the machine learning model 730. In the illustrated example, once pre-training is complete (e.g., when the machine learning model 730 is sufficiently trained, when no additional synthetic data remains for training, when a defined amount of time or resources have been spent pre-training, and the like), the system may transition to the adaptation stage at block 705B.

As illustrated in block 705B, position information (e.g., GPS data 710B) and/or other modality data (e.g., image data 715B) are collected in the real environment around the base station 735. That is, the system may capture actual images (e.g., the image data 117A of FIG. 1) and actual location data (e.g., the location data 117D of FIG. 1) during scene adaptation in block 705B.

In the illustrated example, the position information is again used as input to the simulator 725 (as discussed above) to predict a best beam (e.g., the LOS beam). Additionally, as illustrated, this beam is indicated to the base station 735, and the actual received power for this predicted beam (as transmitted and/or received by the base station 735) can be determined. In the illustrated example, the predicted received power (predicted by the simulator) and the actual received power (determined by the base station) can be compared at operation 740.

Specifically, in some aspects, the difference between the simulated or predicted power and the actual or measured power can be determined. In some aspects, if this difference satisfies one or more criteria (e.g., meeting or exceeding a threshold), the system can determine that additional data should be collected (as indicated by the dotted line between operation 740 and base station 735). If not, the machine learning system may determine that additional data for the UE position is unnecessary.

That is, if the difference between the predicted power of the best beam and the actual power of the selected beam (roughly) align, the system need not measure each other beam for the current position of the UE (e.g., the received power when using each other element in the codebook). In the illustrated example, if the difference exceeds the threshold, the machine learning system may initiate or request that a full sweep be measured (e.g., measuring actual received power at the remaining (non-selected) beams/codebook elements). For example, the predicted beam (e.g., the LOS beam) may have lower actual received power than predicted due to obstacles, RF reflection, refraction, and/or absorption, and the like. In such cases, due to the specific environment of the base station 735, additional real-world data can be collected to train improved models.

In the illustrated example, during the scene adaptation phase in block 705B, these actual measurements (for the initially selected beam and/or for additional beams, if the predicted power and received power differ substantially) can be used as target output or labels to train the machine learning model 730 (which was pre-trained at block 705A). Additionally, the corresponding input modalities (e.g., GPS data 710B and image data 715B) can be similarly used as the input during this scene adaptation. In this way, the machine learning model 730 learns and adapts to the specific scene or environment of the base station 735, and therefore learns to generate or predict the best beam based on the specific environment (e.g., beyond predicting a simple LOS beam).

As illustrated, such adaptation may be performed using any number of exemplars (e.g., using a variety of UE positions in the environment). Once scene adaptation is complete, the machine learning system may transition to the deployment or runtime phase (illustrated by block 705C). Although the illustrated example suggests a unidirectional workflow (moving from pre-training in block 705A to scene adaptation in block 705B and into deployment in block 705C), in some aspects, the machine learning system may freely move between phases depending on the particular implementation (e.g., re-entering adaptation in block 705B periodically or when model performance or communication efficacy degrades).

In the illustrated example, for the deployment phase in block 705C, the simulator 725 can be discarded (or otherwise unused), and the trained and/or adapted machine learning model 730 can be used to process input modalities (e.g., GPS data 710C and image data 715C) to select or predict the best beam(s). This prediction can then be provided to the base station 735 and used to drive beam selection by the base station 735, substantially improving communications, as discussed above.

In some aspects, the particular loss(es) used to refine the various models described herein (such as the depicted machine learning model 730) may vary depending on the particular implementation. For example, for classification tasks, cross-entropy (CE) loss may be considered a standard choice for training deep models. In some aspects, the CE loss to train the models may be defined using Equation 1 below, where yₙ is the index of the (predicted) best beam, C is the number of codebooks (e.g., the number of elements or beams in the codebook 720), and N is the batch size:

$${ℒ}_{CE} ( y , \hat{y} ) = - \frac{1}{N} {\sum }_{n = 1}^{N} {\sum }_{c = 1}^{C} log ( \frac{exp ( {\hat{y}}_{n , c} )}{{\sum }_{i = 1}^{C} exp ( {\hat{y}}_{n , i} )} ) {y}_{n , c} \qquad ( 1 )$$

In some aspects, while the CE loss focuses on a single value only for the correct label (e.g., a single beam), it may also be true that a second (or third, or fourth) beam (e.g., over one or more reflections) could yield the same or a similar amount of received power. Thus, in some aspects, the machine learning system casts the task to a multi-class estimation problem, such as using binary cross-entropy (BCE) loss. In some aspects, to provide multi-class estimation, the machine learning system can assign or generate weights for each beam, where the highest-weighted beams become the target label during training. In some aspects, BCE loss to train the models is defined using Equation 2 below, where C is the number of codebook entries in the codebook 720 and the number of “simultaneous” classes (e.g., the number of good candidates or beams to predict or select) is a sweeping parameter:

$${ℒ}_{BCE} ( y , \hat{y} ) = \frac{1}{C} {\sum }_{c = 1}^{C} - [ {\hat{y}}_{c} log ( {y}_{c} ) + ( 1 - {\hat{y}}_{c} ) log ( 1 - {y}_{c} ) ] \qquad ( 2 )$$

In some aspects, using BCE, the ground-truth beam vector y (also referred to as a label in some aspects) corresponding to the optimal beam(s) may be defined using various strategies. In some aspects, the machine learning system assigns a weight to each beam (e.g., based on predicted or actual received power when using the beam), such that beams having higher received power are weighted higher.

For example, in some aspects, the system may clip the received power profile to a defined power threshold Pt (e.g., defining the target label as all beams having a minimum received power or a minimum weight), such as using Equation 3 below. In some aspects, the system may select the top B beams (e.g., defining the target label as B beams having the most received power or the highest weights), such as using Equation 4 below:

$$y = \{ \begin{matrix}{y}_{i} & \geq {p}_{t} \\ 0 , & otherwise\end{matrix} \qquad ( 3 )$$

$$y = \{ \begin{matrix}\frac{1}{i + 1} , & ∀ i ∈ B \\ 0 , & otherwise\end{matrix} \qquad ( 4 )$$

In this way, the system can train the models using labels and loss formulations that allow the machine learning model 730 to learn using more than one beam as the target for a given input sample.

### Example Method for Fusion-Based Beam Selection

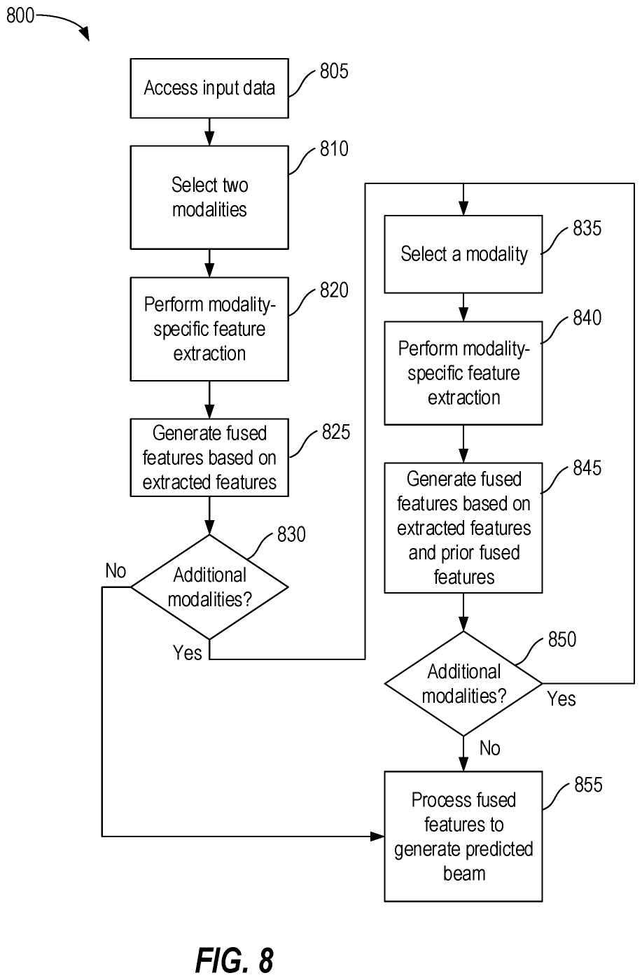

FIG. 8 is a flow diagram depicting an example method 800 for improved beam selection by fusing data modalities. In some aspects, the method 800 is performed by a machine learning system, such as the machine learning system 125 of FIG. 1.

In some aspects, the method 800 provides additional detail for beam selection using the architecture 500 of FIG. 5, the architecture 600 of FIG. 6, and/or the machine learning model 730 of FIG. 7. Generally, the method 800 may be used during training (e.g., during a forward pass of data through the model, where a backward pass is then used to update the parameters of each component of the architecture), as well as during inferencing (e.g., when input data is processed to select one or more beams during runtime).

At block 805, the machine learning system accesses input data. As used herein, “accessing” data generally includes receiving, retrieving, collecting, generating, determining, measuring, requesting, obtaining, or otherwise gaining access to the data. As discussed above, this input data may include data for any number of modalities, such as images (e.g., the image data 117A of FIG. 1), radar data (e.g., the radar data 117B of FIG. 1), LIDAR data (e.g., the LIDAR data 117C of FIG. 1), location data (e.g., the location data 117D of FIG. 1), and the like. In some aspects, as discussed above, the input data includes a time series of data (e.g., a sequence of data for each modality).

At block 810, the machine learning system selects two or more of the modalities to be fused. In some aspects, if non-sequential fusion is used (e.g., as discussed above with reference to FIG. 5), the machine learning system may select all of the available modalities at block 810. In some aspects, if sequential fusion is used (as discussed above with reference to FIG. 6), the machine learning system may select two modalities. As discussed above, the particular order used to select the modalities for sequential fusion may vary depending on the particular implementation, and in some aspects, any two modalities may be selected for the first fusion.

At block 820, the machine learning system performs modality-specific feature extraction on each of the selected modalities. For example, as discussed above, the machine learning system may use the modality-specific feature extractions 510 of FIG. 5 and/or the modality-specific feature extractions 610 of FIG. 6 for each modality to generate corresponding features.

At block 825, the machine learning system then generates fused features based on the extracted features for the selected modalities. For example, as discussed above, the machine learning system may use a fusion component (e.g., the fusion component 515 of FIG. 5) and/or an attention-based architecture such as a transformer model (e.g., the encoder-decoder fusion model 615 of FIG. 6) to fuse the extracted features.

At block 830, the machine learning system determines whether there is at least one additional modality reflected in the input data accessed at block 805 (e.g., if sequential fusion is used). If not, then the method 800 continues to block 855, where the machine learning system processes the fused features to generate one or more predicted beams. For example, if a time-series is used, the machine learning system may use a GRU network and/or a classifier to process the fused features and generate a predicted beam (e.g., the predicted beam 530 of FIG. 5).

Returning to block 830, if the machine learning system determines that there is at least one additional modality, then the method 800 continues to block 835, where the machine learning system selects one of the remaining modalities.

At block 840, the machine learning system performs modality-specific feature extraction on the selected modality. For example, as discussed above, the machine learning system may use the modality-specific feature extraction 510 of FIG. 5 and/or the modality-specific feature extraction 610 of FIG. 6 for the specific selected modality to generate corresponding features.

At block 845, the machine learning system then generates fused features based on the extracted features for the selected modality and the previously generated fused features for the prior modalities (e.g., generated at block 825, or generated at block 845 during a prior iteration of blocks 835-750). For example, as discussed above, the machine learning system may use an attention-based architecture such as a transformer model (e.g., the encoder-decoder fusion model 615 of FIG. 6) to fuse the extracted features with the fused features from the prior fusion model (e.g., the features that have already been fused by earlier layers).

At block 850, the machine learning system determines whether there is at least one additional modality reflected in the input data accessed at block 805. If so, then the method 800 returns to block 835 to select the next modality for processing and fusing. If no further modalities remain, then the method 800 continues to block 855, where the machine learning system processes the fused features to generate one or more predicted beams.

For example, as discussed above, the machine learning system may use one or more machine learning models and/or classifiers to select one or more beams based on the data. In some aspects, if a sequence or time-series is used, the machine learning system may use recurrent model such as a GRU network to process the fused features and generate the predicted beam(s).

In this way, the machine learning system can generate and fuse modality-specific features to drive improved beam selection. As discussed above, this/these predicted beam(s) may correspond to the beam(s) which are predicted or expected to provide the best available communications to the UE, such as the most robustness, the highest throughput, and the like. Advantageously, by using attention-based models to fuse the features from each modality, the machine learning system is able to achieve high robustness and accuracy (e.g., reliably selecting or suggesting the most-optimal beam for the communications).

Although not depicted in the illustrated example, the method 800 may additionally include actually facilitating communication with the UE based on the predicted beam(s). For example, facilitating the communication may include indicating or providing the predicted beam(s) to the base station, instructing the base station to use the indicated beam(s), actually using the beam(s) (e.g., if the machine learning system operates as a component of the base station itself), and the like.

Additionally, although not depicted in the illustrated example, the method 800 may then return to block 805 to access new input data in order to generate an updated set of predicted beam(s). For example, the method 800 may be performed continuously, periodically (e.g., every five seconds), and the like.

Further, although not depicted in the illustrated example, in some aspects, the method 800 may be performed separately (sequentially or in parallel) for each UE wirelessly connected to the base station. That is, for each respective associated UE, the machine learning system may access corresponding input data for the UE to generate predicted beam(s) for communicating with the respective UE. In some aspects, some of the input data (such as image data and radar data) may be shared/global across multiple UEs, while some of the input data (such as location data) is specific to the respective UE.

### Example Method for Pre-training and Scene Adaptation

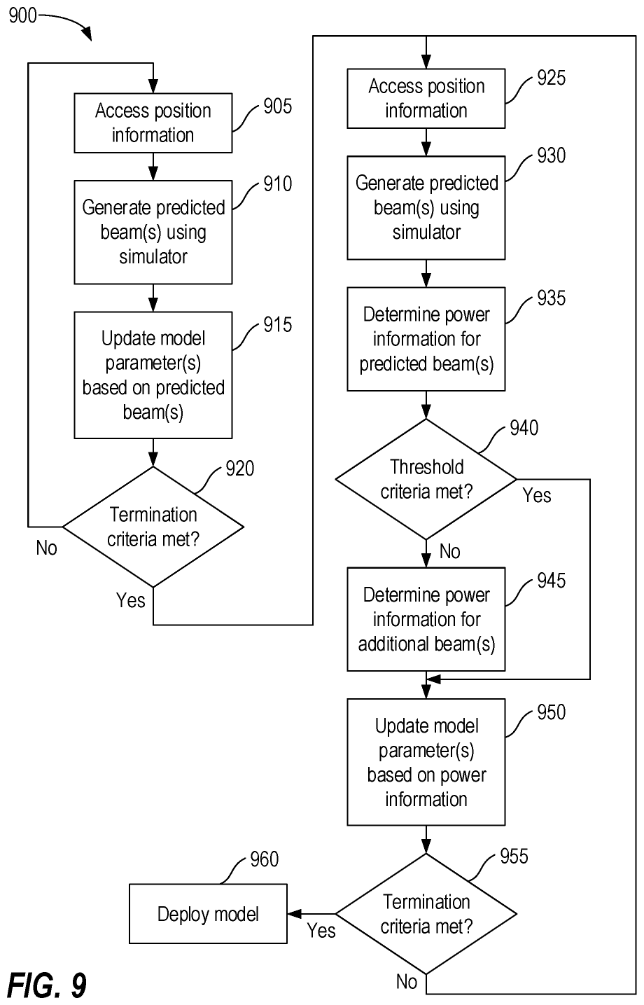

FIG. 9 is a flow diagram depicting an example method 900 for pre-training and scene adaptation. In some aspects, the method 900 is performed by a machine learning system, such as the machine learning system 125 of FIG. 1. In some aspects, the method 900 is performed entirely or partially by a dedicated training system. For example, one part of the method 900 (e.g., pre-training in blocks 905, 910, 915, and 920) may be performed by a dedicated training system, and scene or environment adaptation (in blocks 925, 930, 935, 940, 945, 950, and 955) may be performed by a machine learning system that uses trained models to generate predicted beams during runtime. In some aspects, the method 900 provides additional detail for the workflow 700 of FIG. 7.

At block 905, the machine learning system accesses position information (e.g., the location data 117D of FIG. 1 and/or the GPS data 710A of FIG. 7). In some aspects, as discussed above, the position information comprises coordinates (e.g., GPS coordinates) of a UE and a base station. In some aspects, the position information includes angle and/or range information indicating the position of the UE relative to the base station. As discussed above, in some aspects, the position information accessed at block 905 may comprise simulated position data. That is, the position data may indicate a position (e.g., an angle) relative to a base station, without correspondence to a physical UE or other equipment. In other aspects, this position information may comprise actual position data (e.g., the position of a physical UE in an environment, relative to the base station).

At block 910, the machine learning system generates one or more predicted beams, based on the position information, using a simulator (e.g., the simulator 725 of FIG. 7). For example, as discussed above, the simulator may comprise a mapping between angle of arrival and codebook entries or beams, such that the simulator can be used to identify one or more beam(s) that correspond to the position information.

At block 915, the machine learning system updates one or more parameters of a machine learning model (e.g., the machine learning model 730) based on the predicted beam(s) identified using the simulator. Generally, the particular techniques used to update the model parameters may vary depending on the particular implementation. For example, in the case of a neural network, the machine learning system may generate an output of the model (e.g., one or more selected beams and/or predicted received power for one or more beams) based on input (e.g., based on the position information and/or one or more other modalities, such as image data, radar data, LIDAR data, and the like). This model output can then be compared against the beam(s) and/or received power predicted by the simulator to generate a loss (e.g., using Equation 1 and/or Equation 2 above). This loss can then be used to refine the model parameters (e.g., using backpropagation).

In some aspects, updating the model parameters may include updating one or more parameters related to beam selection, rather than feature extraction. That is, the machine learning system may use pre-trained feature extractors for each data modality (either trained by the machine learning system, or by another system), and may refrain from modifying these feature extractors during the method 900. In other aspects, the machine learning system may optionally update one or more parameters of the feature extractors as well during the method 900.

In some aspects, as discussed above, this pre-training operation can be used to train the model to select LOS beams based on position information. Additionally, as discussed above, the optional use of other modalities during this pre-training can cause the model to become invariant with respect to aspects that do not affect communication efficacy, such as the appearance or radar cross section of the UE.

At block 920, the machine learning system determines whether one or more pre-training criteria are met. Generally, the particular termination criteria may vary depending on the particular implementation. For example, determining whether the pre-training criteria are satisfied may include determining whether additional samples or exemplars remain for training, determining whether the machine learning model exhibits a minimum or desired accuracy with respect to beam prediction, determining whether the model accuracy is continuing to improve (or has stalled), determining whether a defined amount of time or computational resources have been spent during pre-training, and the like.

If, at block 920, the machine learning system determines that the pre-training termination criteria are not met, the method 900 returns to block 905 to continue pre-training. Although the illustrated example depicts a stochastic training operation for conceptual clarity (e.g., where the model is updated using stochastic gradient descent based on independent data samples), in some aspects, the machine learning system may use a batch training operation (e.g., refining the model using batch gradient descent based on a set of data samples). If, at block 920, the machine learning system determines that the pre-training termination criteria are met, the method 900 continues to block 925 to begin scene or environment adaptation.

At block 925, the machine learning system accesses position information (e.g., the location data 117D of FIG. 1 and/or the GPS data 710B of FIG. 7). In some aspects, as discussed above, the position information comprises coordinates (e.g., GPS coordinates) of a UE and a base station in a real or physical environment. In some aspects, the position information includes angle and/or range information indicating the position of the UE relative to the base station in the environment.

At block 930, the machine learning system generates one or more predicted beams, based on the position information, using a simulator (e.g., the simulator 725 of FIG. 7). For example, as discussed above, the simulator may comprise a mapping between angle of arrival and codebook entries or beams, such that the simulator can be used to identify one or more LOS beam(s) that correspond to the position information. In some aspects, the simulator also indicates or generates predicted power information for the beams based on the position information (e.g., based on the angle and/or range to the UE). For example, the predicted beam(s) may indicate the predicted amount of power that will be received if the beam(s) are used to communicate with the UE at the position.

At block 935, the machine learning system determines actual power information for the predicted beam(s). For example, as discussed above, the machine learning system may instruct, request, or otherwise cause the base station to communicate with the UE using the indicated beam(s), measuring the actual received power that results.

At block 940, the machine learning system determines whether one or more threshold criteria are met, with respect to the actual received power. For example, in some aspects, the machine learning system may determine whether the predicted beams resulted in satisfactory or acceptable received power (or resulted in the highest received power, such as by testing one or more adjacent beams). In some aspects, the machine learning system may determine the difference between the predicted power (generated by the simulator) and the actual power (determined in the environment). If the difference is less than a threshold, the method 900 may continue to block 950. That is, if the actual received power is similar to the predicted received power, the machine learning system may determine or infer that the position of the UE (determined at block 925) results in a clear LOS to the UE, or otherwise causes the LOS beam(s) to yield actual received power that closely matches the predicted power. For these positions, the machine learning system may determine to forgo further data collection (e.g., sweeping the codebook), thereby substantially reducing the time, computational expense, and power consumption used to perform such data collection for the UE position.

If, at block 940, the machine learning system determines that the threshold criteria are not met (e.g., the difference between the actual and predicted received power is greater than the threshold), the method 900 continues to block 945. That is, if the actual received power is dissimilar from the predicted received power, the machine learning system may determine or infer that the position of the UE (determined at block 925) does not result in a clear LOS to the UE (e.g., because of obstructions, reflections, and the like), or otherwise causes the LOS beam(s) to yield actual received power that does not closely match the predicted power. For these positions, the machine learning system may determine that further data collection (e.g., sweeping the codebook) would be beneficial to model accuracy.

At block 945, the machine learning system determines power information for one or more additional beams. For example, as discussed above, the machine learning system may instruct, request, or otherwise cause the base station to sweep through the codebook, communicating with the UE using each alternative beam, and measuring the actual received power that results from each beam.

At block 950, the machine learning system updates the model parameters based on the power information (determined at block 935 and/or at block 945). That is, if the machine learning system determined not to sweep the codebook (e.g., determining at block 940 that the threshold criteria are met), the machine learning system may update the model parameter(s) based on the actual received power for the selected beam(s) (selected at block 930). If the machine learning system determined to sweep the codebook (e.g., determining at block 940 that the threshold criteria are not met), the machine learning system may update the model parameters based on all of the power information determined at blocks 935 and 945.

As discussed above, the particular techniques used to update the model parameters may generally vary depending on the particular implementation. For example, in the case of a neural network, the machine learning system may generate one or more outputs of the model (e.g., one or more selected beams and/or predicted received power for one or more beams) based on input (e.g., based on the position information and/or one or more other modalities, such as image data, radar data, LIDAR data, and the like). This model output can then be compared against the beam(s) and/or received power predicted by the simulator to generate a loss (e.g., using Equation 1 and/or Equation 2 above). This loss can then be used to refine the model parameters (e.g., using backpropagation).

In some aspects, as discussed above, updating the model parameters may include updating one or more parameters related to beam selection, rather than feature extraction. That is, the machine learning system may use pre-trained feature extractors for each data modality (either trained by the machine learning system, or by another system), and may refrain from modifying these feature extractors during the method 900. In other aspects, the machine learning system may optionally update one or more parameters of the feature extractors as well during the method 900.

At block 955, the machine learning system determines whether one or more adaptation termination criteria are met. Generally, the particular termination criteria may vary depending on the particular implementation. For example, determining whether the adaptation termination criteria are satisfied may include determining whether additional samples or exemplars remain for training, determining whether the machine learning model exhibits a minimum or desired accuracy with respect to beam prediction, determining whether the model accuracy is continuing to improve (or has stalled), determining whether a defined amount of time or computational resources have been spent during environment adaptation, and the like.

If, at block 955, the machine learning system determines that the adaptation termination criteria are not met, the method 900 returns to block 925 to continue performing environment adaptation. Although the illustrated example depicts a stochastic training operation for conceptual clarity (e.g., where the model is updated using stochastic gradient descent based on independent data samples), in some aspects, the machine learning system may use a batch training operation (e.g., refining the model using batch gradient descent based on a set of data samples).

If, at block 955, the machine learning system determines that the adaptation termination criteria are met, the method 900 continues to block 960. At block 960, the machine learning system deploys the model (or otherwise enters a runtime or deployment phase). For example, as discussed above with reference to block 705C of FIG. 7, the machine learning system may begin processing input data (e.g., position information, image data, and the like) using the trained model to generate or select optimal beams for communication.

### Example Method for Wireless Communication Configuration

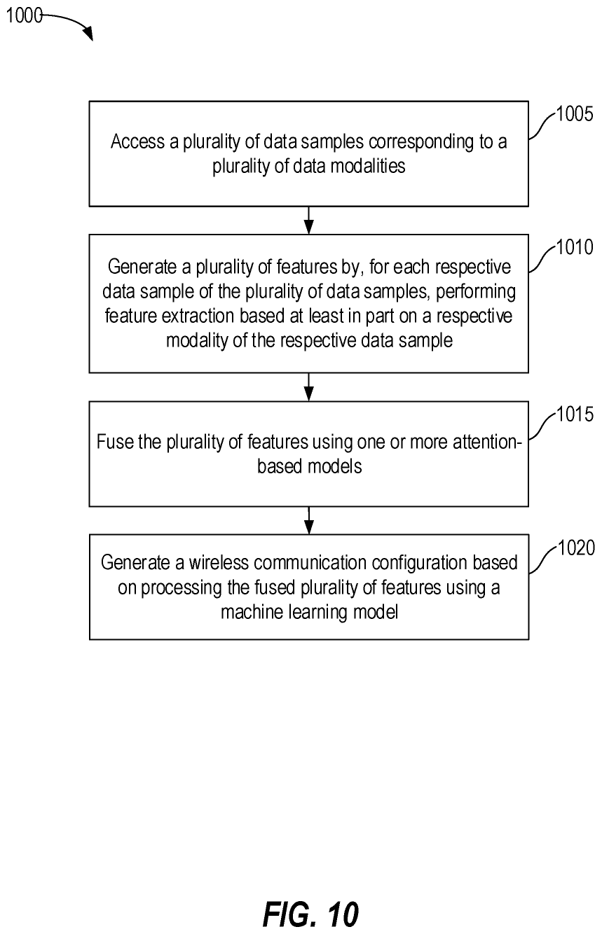

FIG. 10 is a flow diagram depicting an example method 1000 for improved wireless communication configuration using machine learning. In some aspects, the method 1000 is performed by a machine learning system, such as the machine learning system 125 of FIG. 1.

At block 1005, a plurality of data samples corresponding to a plurality of data modalities is accessed. In some aspects, the plurality of data modalities comprises at least one of: (i) image data, (ii) radar data, (iii) LIDAR data, or (iv) relative positioning data.

At block 1010, a plurality of features is generated by, for each respective data sample of the plurality of data samples, performing feature extraction based at least in part on a respective modality of the respective data sample. In some aspects, performing feature extraction comprises, for a first data sample of the plurality of data samples: determining a first modality, from the plurality of data modalities, of the first data sample; selecting a trained feature extraction model based on the first modality; and generating a first set of features by processing the first data sample using the trained feature extraction model.

At block 1015, the plurality of features is fused using one or more attention-based models.

At block 1020, a wireless communication configuration is generated based on processing the fused plurality of features using a machine learning model.

In some aspects, the plurality of data samples comprises, for each respective data modality of the plurality of data modalities, a sequence of data samples. In some aspects, the fused plurality of features comprises a sequence of fused features. In some aspects, the machine learning model comprises a time-series-based machine learning model that processes the sequence of fused features to generate the wireless communication configuration.

In some aspects, the wireless communication configuration comprises a selection of a beam for performing wireless communications with one or more wireless devices. In some aspects, the method 1000 further includes facilitating wireless communications with the one or more wireless devices using the selected beam.

In some aspects, the machine learning model is trained using a pre-training operation. The pre-training operation may include: generating a first plurality of predicted beams based on a received power simulator and first relative angle information, and training the machine learning model based on the first plurality of predicted beams and the first relative angle information.

In some aspects, the machine learning model is refined using an adaptation operation. The adaptation operation may involve: generating a second plurality of predicted beams based on the received power simulator and second relative angle information, measuring actual received power information based on the second plurality of predicted beams, and training the machine learning model based on the actual received power information and the second relative angle information. In some aspects, the adaptation operation further comprises: in response to determining that the actual received power information differs from predicted received power information beyond a threshold, measuring actual received power information for at least one additional beam, and training the machine learning model based on the actual received power information for the at least one additional beam and the second relative angle information.

In some aspects, training the machine learning model comprises: generating a plurality of weights for the first plurality of predicted beams based on received power for each of the first plurality of predicted beams, generating a binary cross-entropy loss based on the plurality of weights, and updating one or more parameters of the machine learning model based on the binary cross-entropy loss.

### Example Environment for Fusion-Based Beam Selection

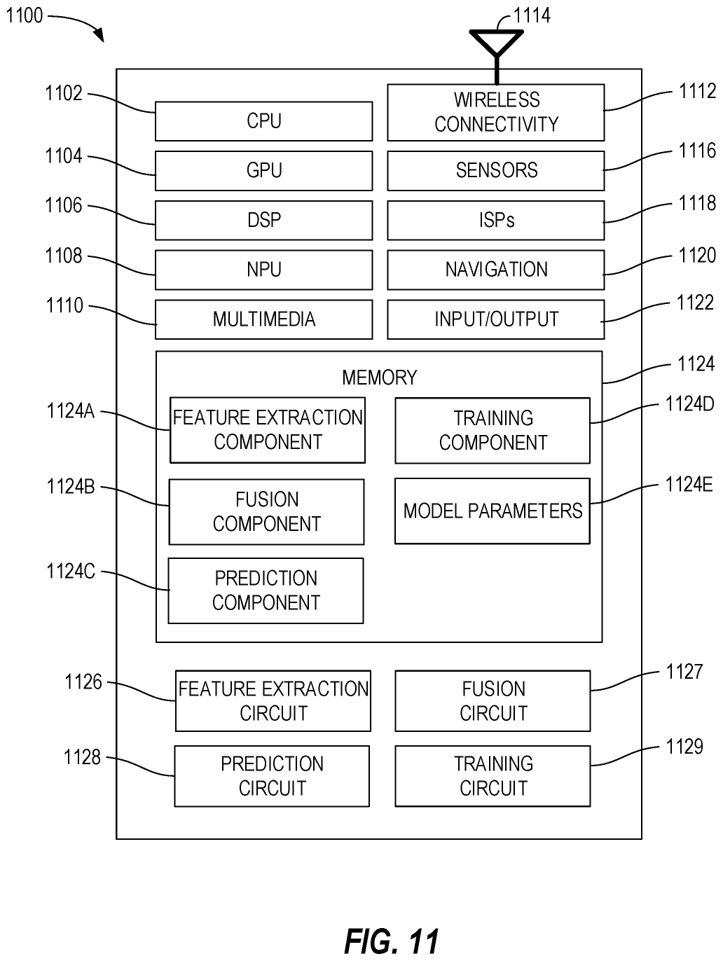

In some aspects, the workflows, techniques, and methods described with reference to FIGS. 1-10 may be implemented on one or more devices or systems. FIG. 11 depicts an example processing system 1100 configured to perform various aspects of the present disclosure, including, for example, the techniques and methods described with respect to FIGS. 1-10. In some aspects, the processing system 1100 may train, implement, or provide a machine learning model for feature fusion, such as the architecture 200 of FIG. 2, the architecture 300 of FIG. 3, the architecture 400 of FIG. 4, the architecture 500 of FIG. 5, and/or the architecture 600 of FIG. 6, and may implement methods and workflows such as the workflow 700 of FIG. 7, the method 800 of FIG. 8, the method 900 of FIG. 9, and/or the method 1000 of FIG. 10. Although depicted as a single system for conceptual clarity, in at least some aspects, as discussed above, the operations described below with respect to the processing system 1100 may be distributed across any number of devices.

The processing system 1100 includes a central processing unit (CPU) 1102, which in some examples may be a multi-core CPU. Instructions executed at the CPU 1102 may be loaded, for example, from a program memory associated with the CPU 1102 or may be loaded from a partition of a memory 1124.

The processing system 1100 also includes additional processing components tailored to specific functions, such as a graphics processing unit (GPU) 1104, a digital signal processor (DSP) 1106, a neural processing unit (NPU) 1108, a multimedia processing unit 1110, and a wireless connectivity component 1112.

An NPU, such as the NPU 1108, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1108, are configured to accelerate the performance of common machine learning tasks, such as image classification, machine translation, object detection, and various other predictive models. In some examples, a plurality of NPUs may be instantiated on a single chip, such as a system on a chip (SoC), while in other examples, the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 1108 is a part of one or more of the CPU 1102, the GPU 1104, and/or the DSP 1106.

In some examples, the wireless connectivity component 1112 may include subcomponents, for example, for third generation (3G) connectivity, fourth generation (4G) connectivity (e.g., 4G Long-Term Evolution (LTE)), fifth generation connectivity (e.g., 5G or New Radio (NR)), sixth generation connectivity (e.g., 6G), Wi-Fi connectivity, Bluetooth connectivity, and other wireless data transmission standards. The wireless connectivity component 1112 is further connected to one or more antennas 1114.

The processing system 1100 may also include one or more sensor processing units 1116 associated with any manner of sensor, one or more image signal processors (ISPs) 1118 associated with any manner of image sensor, and/or a navigation component 1120, which may include satellite-based positioning system components (e.g., for GPS or GLONASS), as well as inertial positioning system components.

The processing system 1100 may also include one or more input and/or output devices 1122, such as screens, touch-sensitive surfaces (including touch-sensitive displays), physical buttons, speakers, microphones, and the like.

In some examples, one or more of the processors of the processing system 1100 may be based on an ARM or RISC-V instruction set.

The processing system 1100 also includes the memory 1124, which is representative of one or more static and/or dynamic memories, such as a dynamic random access memory, a flash-based static memory, and the like. In this example, the memory 1124 includes computer-executable components, which may be executed by one or more of the aforementioned processors of the processing system 1100.

In particular, in this example, the memory 1124 includes a feature extraction component 1124A, a fusion component 1124B, a prediction component 1124C, and a training component 1124D. Though depicted as discrete components for conceptual clarity in FIG. 11, the illustrated components (and others not depicted) may be collectively or individually implemented in various aspects.

In the illustrated example, the memory 1124 further includes a set of model parameters 1124E. The model parameters 1124E may generally correspond to the learnable or trainable parameters of one or more machine learning models, such as used to extract features from various modalities, to fuse modality-specific features, to classify or output beam predictions based on features, and the like.

Though depicted as residing in the memory 1124 for conceptual clarity, in some aspects, some or all of the model parameters 1124E may reside in any other suitable location.

The processing system 1100 further comprises a feature extraction circuit 1126, a fusion circuit 1127, a prediction circuit 1128, and a training circuit 1129. The depicted circuits, and others not depicted, may be configured to perform various aspects of the techniques described herein.

In some aspects, the feature extraction component 1124A and the feature extraction circuit 1126 (which may correspond to the feature extraction 215 and/or the preprocessing 220 of FIG. 2, the feature extraction 308 of FIG. 3, the preprocessing 410 and/or the feature extraction 415 of FIG. 4, the feature extraction 510 of FIG. 5, the feature extraction 610 of FIG. 6, and/or a portion of the machine learning model 730 of FIG. 7) may be used to provide modality-specific feature extraction, as discussed above. For example, the feature extraction component 1124A and the feature extraction circuit 1126 may implement the operations of one or more feature extraction blocks to extract or generate features for input data samples based on the specific modality of the sample.

The fusion component 1124B and the fusion circuit 1127 (which may correspond to the fusion component 515 of FIG. 5, the encoder-decoder fusion models 615 of FIG. 6, and/or a portion of the machine learning model 730 of FIG. 7) may be used to fuse modality-specific features, such as using attention-based mechanisms, as discussed above. For example, the fusion component 1124B and the fusion circuit 1127 may be used to generate fused or aggregated features based on features from independent modalities.

The prediction component 1124C and the prediction circuit 1128 (which may correspond to the machine learning model 225 and/or the classifier 230 of FIG. 2, the machine learning model 320 and/or the classifier 325 of FIG. 3, the machine learning model 425 and/or the classifier 430 of FIG. 4, the machine learning model 520 and/or the classifier 525 of FIG. 5, the machine learning model 620 and/or the classifier 625 of FIG. 6, and/or a portion of the machine learning model 730 of FIG. 7) may be used to generate beam predictions based on single or multi-modality features, as discussed above. For example, the prediction component 1124C and the prediction circuit 1128 may be used to generate or select one or more beams based on the fused input features.

The training component 1124D and the training circuit 1129 may be used to pre-train, train, refine, adapt, or otherwise update machine learning models, as discussed above. For example, the training component 1124D and the training circuit 1129 may be used to train feature extraction components, perform pre-training of the models (e.g., at block 705A of FIG. 7), perform scene or environment adaptation of the models (e.g., at block 705B of FIG. 7), and the like.

Though depicted as separate components and circuits for clarity in FIG. 11, the feature extraction circuit 1126, the fusion circuit 1127, the prediction circuit 1128, and the training circuit 1129 may collectively or individually be implemented in other processing devices of processing system 1100, such as within the CPU 1102, the GPU 1104, the DSP 1106, the NPU 1108, and the like.

Generally, the processing system 1100 and/or components thereof may be configured to perform the methods described herein.

Notably, in other aspects, elements of the processing system 1100 may be omitted, such as where the processing system 1100 is a server computer or the like. For example, the multimedia processing unit 1110, the wireless connectivity component 1112, the sensor processing units 1116, the ISPs 1118, and/or the navigation component 1120 may be omitted in other aspects. Further, elements of the processing system 1100 may be distributed between multiple devices.

### EXAMPLE CLAUSES

In addition to the various aspects described above, specific combinations of aspects are within the scope of the disclosure, some of which are detailed below:

Clause 1: A method comprising: accessing a plurality of data samples corresponding to a plurality of data modalities; generating a plurality of features by, for each respective data sample of the plurality of data samples, performing feature extraction based at least in part on a respective modality of the respective data sample; fusing the plurality of features using one or more attention-based models; and generating a wireless communication configuration based on processing the fused plurality of features using a machine learning model.

Clause 2: A method according to Clause 1, wherein the plurality of data modalities comprises at least one of: (i) image data, (ii) radio detection and ranging (radar) data, (iii) light detection and ranging (LIDAR) data, or (iv) relative positioning data.

Clause 3: A method according to Clause 1 or 2, wherein performing the feature extraction comprises, for a first data sample of the plurality of data samples: determining a first modality, from the plurality of data modalities, of the first data sample; selecting a trained feature extraction model based on the first modality; and generating a first set of features by processing the first data sample using the trained feature extraction model.

Clause 4: A method according to any of Clauses 1-3, wherein: the plurality of data samples comprises, for each respective data modality of the plurality of data modalities, a sequence of data samples; the fused plurality of features comprises a sequence of fused features; and the machine learning model comprises a time-series-based machine learning model that processes the sequence of fused features to generate the wireless communication configuration.

Clause 5: A method according to any of Clauses 1-4, wherein the wireless communication configuration comprises a selection of a beam for performing wireless communications with one or more wireless devices.

Clause 6: A method according to Clause 5, further comprising facilitating wireless communications with the one or more wireless devices using the selected beam.

Clause 7: A method according to any of Clauses 1-6, wherein the machine learning model is trained using a pre-training operation comprising: generating a first plurality of predicted beams based on a received power simulator and first relative angle information; and training the machine learning model based on the first plurality of predicted beams and the first relative angle information.

Clause 8: A method according to Clause 7, wherein the machine learning model is refined using an adaptation operation comprising: generating a second plurality of predicted beams based on the received power simulator and second relative angle information; measuring actual received power information based on the second plurality of predicted beams; and training the machine learning model based on the actual received power information and the second relative angle information.

Clause 9: A method according to Clause 8, wherein the adaptation operation further comprises: in response to determining that the actual received power information differs from predicted received power information beyond a threshold, measuring actual received power information for at least one additional beam; and training the machine learning model based on the actual received power information for the at least one additional beam and the second relative angle information.

Clause 10: A method according to any of Clauses 7-9, wherein training the machine learning model comprises: generating a plurality of weights for the first plurality of predicted beams based on received power for each of the first plurality of predicted beams; generating a binary cross-entropy loss based on the plurality of weights; and updating one or more parameters of the machine learning model based on the binary cross-entropy loss.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processor-implemented method, comprising:
accessing a plurality of data samples corresponding to a plurality of data modalities;
generating a plurality of features by, for each respective data sample of the plurality of data samples, performing feature extraction based at least in part on a respective modality of the respective data sample;
fusing the plurality of features using one or more attention-based models; and
generating a wireless communication configuration based on processing the fused plurality of features using a machine learning model.

2. The processor-implemented method of claim 1, wherein the plurality of data modalities comprises at least one of: (i) image data, (ii) radio detection and ranging (radar) data, (iii) light detection and ranging (LIDAR) data, or (iv) relative positioning data.

3. The processor-implemented method of claim 1, wherein performing the feature extraction comprises, for a first data sample of the plurality of data samples:
determining a first modality, from the plurality of data modalities, of the first data sample;
selecting a trained feature extraction model based on the first modality; and
generating a first set of features by processing the first data sample using the trained feature extraction model.

4. The processor-implemented method of claim 1, wherein:
the plurality of data samples comprises, for each respective data modality of the plurality of data modalities, a sequence of data samples;
the fused plurality of features comprises a sequence of fused features; and
the machine learning model comprises a time-series-based machine learning model that processes the sequence of fused features to generate the wireless communication configuration.

5. The processor-implemented method of claim 1, wherein the wireless communication configuration comprises a selection of a beam for performing wireless communications with one or more wireless devices.

6. The processor-implemented method of claim 5, further comprising facilitating wireless communications with the one or more wireless devices using the selected beam.

7. The processor-implemented method of claim 1, wherein the machine learning model is trained using a pre-training operation comprising:
generating a first plurality of predicted beams based on a received power simulator and first relative angle information; and
training the machine learning model based on the first plurality of predicted beams and the first relative angle information.

8. The processor-implemented method of claim 7, wherein the machine learning model is refined using an adaptation operation comprising:
generating a second plurality of predicted beams based on the received power simulator and second relative angle information;
measuring actual received power information based on the second plurality of predicted beams; and
training the machine learning model based on the actual received power information and the second relative angle information.

9. The processor-implemented method of claim 8, wherein the adaptation operation further comprises:
in response to determining that the actual received power information differs from predicted received power information beyond a threshold, measuring actual received power information for at least one additional beam; and
training the machine learning model based on the actual received power information for the at least one additional beam and the second relative angle information.

10. The processor-implemented method of claim 7, wherein training the machine learning model comprises:
generating a plurality of weights for the first plurality of predicted beams based on received power for each of the first plurality of predicted beams;
generating a binary cross-entropy loss based on the plurality of weights; and
updating one or more parameters of the machine learning model based on the binary cross-entropy loss.

11. A processing system comprising:
a memory comprising computer-executable instructions; and
one or more processors configured to execute the computer-executable instructions to cause the processing system to:
access a plurality of data samples corresponding to a plurality of data modalities;
perform feature extraction to generate a plurality of features for the plurality of data samples based at least in part on a respective modality of each respective data sample of the plurality of data samples;
fuse the plurality of features using one or more attention-based models; and
generate a wireless communication configuration based on processing the fused plurality of features using a machine learning model.

12. The processing system of claim 11, wherein the plurality of data modalities comprises at least one of: (i) image data, (ii) radio detection and ranging (radar) data, (iii) light detection and ranging (LIDAR) data, or (iv) relative positioning data.

13. The processing system of claim 11, wherein to perform the feature extraction for a first data sample of the plurality of data samples, the one or more processors are configured to execute the computer-executable instructions to cause the processing system to:
determine a first modality, from the plurality of data modalities, of the first data sample;
select a trained feature extraction model based on the first modality; and
generate a first set of features by processing the first data sample using the trained feature extraction model.

14. The processing system of claim 11, wherein:
the plurality of data samples comprises, for each respective data modality of the plurality of data modalities, a sequence of data samples;
the fused plurality of features comprises a sequence of fused features; and
the machine learning model comprises a time-series-based machine learning model that processes the sequence of fused features to generate the wireless communication configuration.

15. The processing system of claim 11, wherein the wireless communication configuration comprises a selection of a beam for performing wireless communications with one or more wireless devices.

16. The processing system of claim 15, wherein the one or more processors are further configured to execute the computer-executable instructions to cause the processing system to facilitate wireless communications with the one or more wireless devices using the selected beam.

17. The processing system of claim 11, wherein the machine learning model is trained using a pre-training operation, wherein to perform the pre-training operation, the one or more processors are configured to execute the computer-executable instructions to cause the processing system to:
generate a first plurality of predicted beams based on a received power simulator and first relative angle information; and
train the machine learning model based on the first plurality of predicted beams and the first relative angle information.

18. The processing system of claim 17, wherein the machine learning model is refined using an adaptation operation, wherein to perform the adaptation operation, the one or more processors are configured to execute the computer-executable instructions to cause the processing system to:
generate a second plurality of predicted beams based on the received power simulator and second relative angle information;
measure actual received power information based on the second plurality of predicted beams; and
train the machine learning model based on the actual received power information and the second relative angle information.

19. The processing system of claim 18, wherein to perform the adaptation operation, the one or more processors are further configured to execute the computer-executable instructions to cause the processing system to:
in response to determining that the actual received power information differs from predicted received power information beyond a threshold, measure actual received power information for at least one additional beam; and
train the machine learning model based on the actual received power information for the at least one additional beam and the second relative angle information.

20. The processing system of claim 17, wherein, to train the machine learning model, the one or more processors are configured to execute the computer-executable instructions to cause the processing system to:
generate a plurality of weights for the first plurality of predicted beams based on received power for each of the first plurality of predicted beams;
generate a binary cross-entropy loss based on the plurality of weights; and
update one or more parameters of the machine learning model based on the binary cross-entropy loss.

21. A non-transitory computer-readable medium comprising computer-executable instructions that, when executed by one or more processors of a processing system, cause the processing system to:
access a plurality of data samples corresponding to a plurality of data modalities;
perform feature extraction to generate a plurality of features for the plurality of data samples based at least in part on a respective modality of each respective data sample of the plurality of data samples;
fuse the plurality of features using one or more attention-based models; and
generate a wireless communication configuration based on processing the fused plurality of features using a machine learning model.

22. The non-transitory computer-readable medium of claim 21, wherein the plurality of data modalities comprises at least one of: (i) image data, (ii) radio detection and ranging (radar) data, (iii) light detection and ranging (LIDAR) data, or (iv) relative positioning data.

23. The non-transitory computer-readable medium of claim 21, wherein to perform the feature extraction for a first data sample of the plurality of data samples, the one or more processors are configured to execute the computer-executable instructions to cause the processing system to:
determine a first modality, from the plurality of data modalities, of the first data sample;
select a trained feature extraction model based on the first modality; and
generate a first set of features by processing the first data sample using the trained feature extraction model.

24. The non-transitory computer-readable medium of claim 21, wherein:
the plurality of data samples comprises, for each respective data modality of the plurality of data modalities, a sequence of data samples;
the fused plurality of features comprises a sequence of fused features; and
the machine learning model comprises a time-series-based machine learning model that processes the sequence of fused features to generate the wireless communication configuration.

25. The non-transitory computer-readable medium of claim 21, wherein the wireless communication configuration comprises a selection of a beam for performing wireless communications with one or more wireless devices.

26. The non-transitory computer-readable medium of claim 25, wherein the computer-executable instructions, when executed by the one or more processors of the processing system, further cause the processing system to facilitate wireless communications with the one or more wireless devices using the selected beam.

27. The non-transitory computer-readable medium of claim 21, wherein the machine learning model is trained using a pre-training operation, wherein to perform the pre-training operation, the one or more processors are configured to execute the computer-executable instructions to cause the processing system to:
generate a first plurality of predicted beams based on a received power simulator and first relative angle information; and
train the machine learning model based on the first plurality of predicted beams and the first relative angle information.

28. The non-transitory computer-readable medium of claim 27, wherein the machine learning model is refined using an adaptation operation, wherein to perform the adaptation operation, the one or more processors are configured to execute the computer-executable instructions to cause the processing system to:
generate a second plurality of predicted beams based on the received power simulator and second relative angle information;
measure actual received power information based on the second plurality of predicted beams; and
train the machine learning model based on the actual received power information and the second relative angle information.

29. The non-transitory computer-readable medium of claim 28, wherein to perform the adaptation operation, the one or more processors are further configured to execute the computer-executable instructions to cause the processing system to:
in response to determining that the actual received power information differs from predicted received power information beyond a threshold, measure actual received power information for at least one additional beam; and
train the machine learning model based on the actual received power information for the at least one additional beam and the second relative angle information.

30. A processing system, comprising:
means for accessing a plurality of data samples corresponding to a plurality of data modalities;
means for generating a plurality of features by, for each respective data sample of the plurality of data samples, performing feature extraction based at least in part on a respective modality of the respective data sample;
means for fusing the plurality of features using one or more attention-based models; and
means for generating a wireless communication configuration based on processing the fused plurality of features using a machine learning model.
